(19) United States
(12) Patent Application Publication
(10) Pub. No.: US 2017/0069940 A1
(43) Pub. Date: Mar. 9, 2017

(54) BATTERY CELLS AND ARRANGEMENTS

(71) Applicant: Unicell LLC, Valley Cottage, NY (US)

(72) Inventors: Jonathan R. Goldstein, Jerusalem (IL); Arieh Meitav, Rishon LeZion (IL); Shalom Luski, Rehovot (IL)

(21) Appl. No.: 15/121,205

(22) PCT Filed: Mar. 4, 2015
(86) PCT No.: PCT/IL2015/050229

§ 371 Date: Aug. 24, 2016

Related U.S. Application Data
(60) Provisional application No. 61/948,572, filed on Mar. 6, 2014.

(30) Foreign Application Priority Data
Dec. 15, 2014 (IL) 236273

(51) Int. Cl. H01M 10/6557; H01M 2/20; H01M 10/613; H01M 2/02

(52) U.S. Cl. CPC H01M 10/6557; H01M 2/0287; H01M 2/0285; H01M 2/028; H01M 2/206; H01M 10/613

(57) ABSTRACT

A battery cell unit is presented, the battery cell unit comprising: a metallic enclosure comprising: a first metallic case having a base tray and surrounding walls thereby defining an inner volume, a second metallic case-cover being configured for closing said inner volume, and a circumferential sealing material located along an interface between said first metallic case and said second metallic case cover to thereby seal said volume within the enclosure. The battery also comprises anode and cathode elements being separated between them by a separator. The anode and cathode elements and the separator are immersed in electrolytic liquid to thereby allow ion exchange between the anode and cathode elements while preventing direct contact between them. The anode and cathode elements are respectively electrically connected to the metallic enclosure and metallic case cover.

### FIELD OF THE INVENTION

The present invention relates generally to battery cell units and to methods for forming battery cell units suitable for use in battery arrangements.

### BACKGROUND OF THE INVENTION

Batteries have been known for many decades and have been commercially employed in a relatively wide variety of applications. Such batteries include rechargeable lead-acid batteries for starting, lighting and ignition for automobiles, trucks and other vehicles as well as for industrial applications. Rechargeable lithium-ion or nickel-metal hydride battery units are nowadays used in hybrid and electric vehicles and for less energy consuming applications.

Batteries of different chemical materials can be characterized by their voltage (measured in volts) capacity (measured in Ampere-hours) as well as energy and power per weight and/or volume (e.g. Watt hr/unit weight or volume and Watts/unit weight or volume, respectively). Development of new batteries of smaller and lighter size capable of providing higher energy and power is a major target. It is known that while flooded or sealed lead-acid battery systems provide high reliability, such battery systems are relatively limited in the energy and power supply with respect to the Lithium-ion or Nickel-metal hydride battery cells.

Various types of battery cell constructions and packaging techniques are known in the art. Such constructions may be aimed at providing a small form factor while containing anode and cathode elements within an electrolyte to allow storage of electrical energy.

U.S. Pat. No. 6,521,373 discloses an invention comprising in a flat non-aqueous electrolyte secondary coin cell an electricity-generating element including at least a cathode, a separator, an anode and a non-aqueous electrolyte in the inside of a metallic positive pole case closed via a grommet and a calking formulation with a flat circular metallic negative pole. In one embodiment an electrode unit in sheet form consisting of the cathode and the anode opposite to each another via the separator is wound to form an electrode group, one anode extremity is welded internally to the negative pole and one cathode extremity is welded internally to the positive pole. The total sum of the areas of the opposing cathode and anode in this electrode group is larger than the area of the negative pole thereby the discharge capacity upon heavy-loading discharge is significantly increased as compared with conventional coin cells.

U.S. Pat. No. 8,124,270 discloses a prismatic sealed rechargeable battery and includes a substantially prismatic battery case that accommodates an electrode plate assembly and an electrolyte solution. The battery case is formed of metal, but this metal case is electrically floating (i.e. electrically connected neither with cell anode nor cathode within the cell), with conventional negative and positive terminals fitted at the top of the cell. On a side face of the battery case, a thin plate is provided which has a plurality of protruding portions formed in parallel at appropriate intervals. The protruding portion and the side face form spaces opened at both ends therebetween. The thin plate is bonded to the side face of the battery case by making flat portions between the protruding portions into surface-contact with the side face, thereby improving cooling capability of the battery. It should be evident that these protruding portions have no current conducting function.

### SUMMARY OF THE INVENTION

There a need in the art for improved battery cells suitable for use in stackable battery assemblies. The present invention provides an improved battery cell unit and battery assemblies suitable for use in various applications such as electric and hybrid vehicles, mobile power storage units etc. Additionally the present invention also provides a method for producing/forming a battery cell unit and a multi-cell battery assembly. In this connection the battery cell unit according to the present invention may generally be termed semi-bipolar battery cell unit and accordingly a corresponding battery assembly may be termed semi-bipolar assembly. In this connection the following should be noted.

A conventional bipolar battery is configured of positive and negative active materials prepared on opposite sides of a single conductive (e.g. metallic) sheet or substrate forming a bipolar plate. A number of such bipolar plates are combined together with edge sealing to the adjacent bipolar plate. Thus, an individual bipolar battery cell has an anode face, a cathode face, a separator between them, and an electrolyte. The end plates of such a bipolar stack have of course only one type of active material placed internally. Current for charge (in the case of a rechargeable system) and discharge passes directly from cell to cell through the common metallic wall and there is no need for tabs, wiring or an outer case as in conventional monopolar battery construction. In such configuration bipolar battery cells may provide higher power and energy per unit weight and/or volume; however such bipolar batteries may suffer from various disadvantages such as overheating, and may be difficult to produce.

A conventional monopolar battery unit has a battery case holding anode and cathode active materials within electrolyte. Electrical connections to the anode and cathode active materials are provided by external terminals. Differently from bipolar batteries, where electrical connection between battery units may be provided by direct contact between bipolar plates, connection of monopolar batteries generally requires electrical connections such as wires stretching between terminals of the units.

In this connection the term semi-bipolar as used herein generally refers to battery units configured such that selected surfaces of the unit cell provide the positive and negative terminals. Thus serial connection of two or more battery units may be performed by arranging the battery units along a line such that corresponding external surfaces thereof are in electrical contact between them. This configuration allows for simplifying connections between battery cells and forming of relatively small battery assemblies. This is while allowing flexibility in battery design and selection of chemical materials for the active elements of the battery cell.

There is thus provided according to one broad aspect of the present invention, a battery cell unit comprising:

a metallic enclosure comprising a first metallic case having a base tray and surrounding walls thereby defining an inner volume, a second metallic case-cover being configured for closing said inner volume, and a circumferential sealing material located along an interface between said first metallic case and said second metallic case cover, thereby sealing said volume within the enclosure. Anode and cathode elements are separated by a separator, said anode and cathode elements and the separator being immersed in electrolytic liquid to thereby allow charge carrier exchange between the anode and cathode elements while preventing direct contact between them; the anode and cathode elements being respectively electrically connected to the metallic enclosure and metallic case cover.

According to some embodiments a circumference of said interface between the metallic enclosure and the metallic case-cover may be configured with at least one corner. The first metallic enclosure may be configured with a rim about its perimeter such that the rim is extended over edges of the second metallic case cover, separated by an electrically insulating liner. The rim may be crimped about the perimeter of said first metallic enclosure and onto said second metallic case cover to thereby attach said case cover over said enclosure while maintaining electrical insulation between the first metallic enclosure and the second metallic case cover and leaving at least one corner of said perimeter open to provide at least one safety valve for said battery cell unit. Generally, the first metallic enclosure may be embossed from a single sheet of metal (e.g. aluminum).

According to yet some embodiments the second metallic case cover may configured as a clad layered case cover having a first layer of a first metal and a second layer of a second metal. For example, the second metallic case cover may be configured as a clad layer of aluminum and copper (while the first metallic case is configured of aluminum) to allow adjustment of chemical potential, corrosion protection and weight saving in accordance with the anode and cathode active elements of the battery cell unit.

According to yet some additional embodiments the second metallic case cover may configured as two layers case cover by thermal coating of a first layer formed of a first metal by a second layer of a second metal. For example, the case cover may be configured by a first layer formed of copper or aluminum, thermally coated by a second layer formed for aluminum or copper.

Thus according to one broad aspect of the present invention there is provided a battery cell unit comprising: a metallic enclosure comprising a first metallic case having a base tray and surrounding walls thereby defining an inner volume, a second metallic case-cover being configured for closing said inner volume, and a circumferential insulating sealing material located along an interface between said first metallic case and said second metallic case cover to thereby seal said volume within the enclosure; and anode and cathode elements being separated between them by a separator, said anode and cathode elements and the separator being immersed in electrolytic liquid to thereby allow ion exchange between the anode and cathode elements while preventing direct contact between them; the anode and cathode elements being respectively electrically connected to the metallic enclosure and metallic case cover. According to some embodiments, the second metallic case cover may be configured as a clad layered case cover having a first layer of a first metal and a second layer of a second metal. Additionally, the first metallic case may comprise the first metal. The second metallic case-cover my be configured such that said second layer thereof is directed into said inner volume and said first layer thereof is directed out of said inner volume. In some configurations, the first metal may be aluminum (Al) and the second metal may be copper (Cu).

According to some embodiments, the circumference of the interface between the metallic enclosure and the metallic case-cover may comprise at least one corner. The first metallic enclosure may comprise a rim about a perimeter thereof, being extended over edges of said second metallic case cover. The rim may be crimped about the perimeter of said first metallic enclosure and onto said second metallic case cover to thereby attach said case cover over said enclosure while maintaining at least one corner of said perimeter open to provide at least one safety valve for said battery cell unit. The circumference of said interface between the metallic enclosure and the metallic case cover may be configured with a polygonal shape. Additionally or alternatively the circumferential sealing material may be located along an interface between said first metallic case and said second metallic case cover including location of said at least one safety valve.

According to some embodiments, the circumferential sealing material comprises an insulating sealing gasket having a structure selected to fit circumference of said battery cell unit. The circumferential sealing material may further comprise an additional adhesive material spread about said circumference of said battery cell unit.

According to some embodiments the battery cell unit may be configured such that an outer surface of the bottom tray of the first metallic element is a first terminal of the battery cell and a surface of the second metallic element is a second terminal thereof.

Generally, the battery cell unit may further comprise an insulating layer located on external side walls of said battery cell unit thereby providing insulation of the battery cell unit.

According to yet another broad aspect thereof, the present invention provides a battery cell unit comprising a metallic enclosure formed of at least two metallic elements and sealing material between said at least two metallic elements, wherein at least one of said metallic elements being formed as a clad layered metallic element comprising at least two layers of at least two different metals. The enclosure may be sealed with a gasket sealing element and at least one of said at least two metallic elements being crimped over at least one other of said metallic elements to thereby seal interfaces between said elements of the enclosure. Additionally or alternatively, the at least one clad layered metallic element may be formed as a flat metallic element comprising at least one layer of a first material and at least one layer of a second material.

According to yet another broad aspect of the invention, there is provided a battery cell unit comprising: a first metallic case having a substantially polygonal structure; a second metallic case cover; a circumferential sealing material; anode and cathode elements and a separator between them. The anode and cathode elements are respectively electrically connected to the first and second metallic case and case cover. Said first metallic case being crimped over said second metallic case cover along sides of said polygonal structure while leaving at least one corner thereof uncrimped so as to provide a safety vent for said battery cell unit. The second metallic case cover may be a substantially flat element. The second metallic case cover may also be configured as a clad layered metallic element having at least two layers of at least two different metals.

According to some embodiments the circumferential sealing material may comprise a gasket sealing element and adhesive sealing applied along an interface of said first metallic case and said second metallic case cover.

According to yet another broad aspect, the present invention provides a battery assembly comprising at least two battery cell units each configured as described above, corresponding terminals of said at least two battery cell units being electrically connected in series or in parallel between them. The at least two battery cell units may be electrically connected in series, each of said at least two battery cell units may be configured such that a face of a first metallic element is a first terminal and a face of a second metallic element is a second terminal thereof.

According to some embodiments, adjacent battery cell units may be electrically connected between them via at least one metallic connection member providing a plurality of contact points on corresponding faces thereof. The at least one metallic connection member may be a corrugated metallic connection member. The metallic connection member may be configured to allow passage of cooling fluid between said adjacent battery cell units to thereby provide cooling of said battery cell units. Generally, the metallic connection member may be configured such that a distance between adjacent battery cell units is smaller than 20% of a thickness of the battery cell unit, or smaller than 10% of a thickness of the battery cell unit.

The present invention also provides semi-bipolar cells and stacks, with one metallic face of a cell carrying anode material or connecting internally with a support carrying anode active material of a first cell and the other metallic face of the same cell carrying cathode material or connected with a support carrying cathode active material. The current between cells therefore can pass directly from the whole conducting terminal face of each side of the cell to the adjacent cell with no need for tabbing and wiring between cells, giving weight, volume and current takeoff benefits. Cells are spaced to facilitate cooling of the large area terminal faces allowing individual cooling of each cell but the separation distance can be small. In one example for electric vehicle class lithium-ion cells, the large terminal face may be sized of the order of 100 mm×100 mm, and the thickness of the cell around 10 mm. In such a case a desired intercell separation would be no more than 2 mm or no more than 20% of the cell thickness. If volume compactness is not so critical these figures can be exceeded, however for more compact designs the spacing can be reduced to 1 mm or 10% of the cell thickness while maintaining adequate cooling.

In some other embodiments, adjacent terminal faces of cells are electrically connected in series by bolting, screwing, welding or conductive adhesive means of air permeable elements located physically within or substantially within the space between cells and within the footprint of the cell, such that a separation is enabled between cells for cooling purposes. This construction generally offers advantages over the conventional bipolar (for example in cell manufacture), through avoidance of bipolar elements with the problematic situation of anode and cathode active materials on the same bipolar element (contamination possibilities), for eased cell quality control and screening (since cells are separate units prior to battery assembly) and for improved cooling (since cells are spaced apart) while maintaining weight and volume superiority over non-bipolar.

The semi-bipolar cells of the present invention are appropriate to all types of battery systems whether primary or rechargeable, such as lithium-ion, lithium-manganese dioxide, lead-acid, nickel-metal hydride, nickel-zinc, silver-zinc and manganese dioxide-zinc and also to other electrochemical systems with stacked electrodes such as capacitors or supercapacitors. They are adaptable for non-EV applications, such as drones, antenna devices or consumer systems.

There is thus provided according to an embodiment of the present invention a semi-bipolar battery arrangement suitable for use in an electric vehicle including at least two juxtaposed monopolar battery units, each unit including;
a) a substantially planar metallic outer face on one side of the cell comprising the anode (negative) terminal, either supporting anode active material within the cell or electrically connected inside the cell to an anode material support element carrying anode active material;
b) a substantially planar metallic outer face on the other side of the cell comprising the cathode (positive) terminal, either supporting cathode active material within the cell or electrically connected inside the cell to a cathode material support element carrying cathode active material; and
c) a peripheral insulating sealing member between the two faces of the cell and at least one separator layer disposed between the anode and cathode elements, adapted to retain the anode in a short-free configuration at a preselected distance from the cathode and such that the peripheral sealing member completes the unit enclosure, wherein the unit enclosure is configured to house an electrolyte fluid.

Additionally, according to some embodiments of the present invention, each support element further includes an optional insulating layer disposed on an inner face or covering at least one major portion of the support element outside the unit enclosure.

Furthermore, according to some embodiments of the present invention, the semi-bipolar battery includes at least two juxtaposed standalone monopolar battery units.

Moreover, according to some embodiments of the present invention, the semi-bipolar battery arrangement includes a plurality of juxtaposed standalone semi-bipolar battery cells.

Furthermore, according to some embodiments of the present invention, each of the monopolar battery units is selected from an electrode geometry in the group consisting of; two-dimensional (2D); three dimensional (3D), planar, sinusoidal, V-shaped, and combinations thereof. The monopolar units may be constructed using known designs applicable in the art such as rigid prismatic, flexible pouch and the like. Within the monopolar units the active materials on their respective current collectors, appropriately fitted with separator layers, can be disposed in a Z-fold, a jelly roll or a stacked planar plate configuration.

Further, according to some embodiments of the present invention, the semi-bipolar battery further includes;
a) an anode conductive end section adapted for current takeoff from the cell anode terminal face at one extremity of the semi-bipolar stack, and
b) a cathode conductive end section adapted for current takeoff from the cell cathode terminal face at the other extremity of the semi-bipolar stack.

Yet further, according to some embodiments of the present invention, the anode and cathode active materials are selected to reversibly intercalate lithium in rechargeable lithium battery chemistry and the electrolyte fluid is non-aqueous.

By electrolyte fluid is meant the ion-transporting liquid between the anode and cathode in the battery cells. In lithium batteries this fluid is typically a non-aqueous solvent that contains an ionizing salt such as a lithium salt. In aqueous batteries the fluid can be an aqueous acid solution, for example sulphuric acid in the case of lead-acid batteries, or it can be an aqueous alkaline solution, for example potassium hydroxide in the case of nickel-metal hydride batteries. Some specialized electrolytes are based on ionic liquids. The electrolyte fluid can contain performance boosting additives and may be in gelled form or include polymers or polymer precursors. Similar electrolytes are used in capacitors.

Additionally, according to some embodiments of the present invention, the anode and cathode are selected for a rechargeable battery chemistry having an aqueous electrolyte with anodes selected from lead, zinc, metal hydride or iron and cathodes are selected from lead dioxide, nickel hydroxide, silver oxide or manganese dioxide.

Further, according to an embodiment of the present invention, the anode active material includes at least one of lithium, materials to intercalate lithium, carbon, titanium oxide based, silicon-based and tin-based materials for non-aqueous electrolyte systems and magnesium, lead, metal hydride, iron and zinc for aqueous electrolyte systems.

Moreover, according to an embodiment of the present invention, the cathode active material includes at least one of materials to intercalate lithium for non-aqueous electrolyte systems, and lead dioxide, nickel hydroxide, silver oxide, and manganese dioxide for aqueous electrolyte systems. Non-limiting examples for cathodes in lithium cells include transition metal oxides, sulfides and phosphates.

According to another embodiment of the present invention, the cathode active material support element for the various battery chemistries includes at least one of aluminum, steel, stainless steel, titanium, nickel, lead, graphite, carbon, titanium sub-oxide, tin oxide and combinations thereof. The combination can include coating or cladding of one metal by another. As an example, for many lithium-ion battery types the preferred cathode current collector is aluminum.

Additionally, according to an additional embodiment of the present invention, the anode active material support element for the various battery chemistries includes at least one of copper, aluminum, steel, stainless steel, titanium, nickel, lead, graphite, carbon, titanium sub-oxide, tin dioxide and combinations thereof. The combination can include coating or cladding of one metal by another. As an example, for many lithium-ion battery types the preferred anode current collector is copper.

Moreover, according to an embodiment of the present invention, the sealing member includes at least one of polymer, resins, acrylic, thermoplastic, epoxy, silicone and combinations thereof, applied as gasketing, calking, adhesive or multiple layered sheets (such as a 3-ply with aluminum foil sandwiched between nylon and thermoplastic layers). The sealing member may also be fixed in place by a crimping of the metal cell case.

Furthermore, according to an embodiment of the present invention, the electrolyte fluid includes at least one of non-aqueous fluid and combinations thereof.

Additionally, according to an embodiment of the present invention, the separator is selected from at least one of microporous, woven or non-woven polymer, selected from the group consisting of polyolefin, nylon, cellulose, polysulfone, PVDF and combinations thereof.

According to an embodiment of the present invention, the insulating layer is constructed from at least one of polymer, resin, ceramic and combinations thereof.

In a yet further embodiment of the present invention the terminal face on each side of individual cells extends somewhat beyond the cell footprint (defined below) but is bent back to be welded, bolted or riveted to a similar bent back extension from the next cell, the extension and join being arranged to lie completely or substantially within the cell footprint. An element such as a corrugated or even perforated metal plate can then be welded, bolted, screwed or riveted on or near the join point of the extensions. This corrugated piece spaces adjacent cells by a fixed distance to afford mechanical stability to a stack of cells and allows intercell cooling by for example a flow of air directed between the cells. Note this effectively allows excellent cooling to each individual cell of the battery. The corrugated piece will also enable additional conductive contact between adjacent cells.

In a still yet further embodiment of the present invention the terminal face on each side of individual cells (which contains the anode and cathode elements) is welded directly to a corrugated metal piece, thereby firmly fixing it in place. In one option the corrugated metal piece has right angle channels from rectangular or square corrugations and the welding-on step of the terminal face to the corrugated piece is made prior to cell assembly. Other channeled metal spacers are feasible with profiles selected from curved or wave-like shapes, rectangular or square turreted shapes, triangular elements, truncated triangular elements, elements with a straight section followed by a triangular or trapezoid section and combinations of all of these. In another option the corrugated piece is supplied pre-attached or integrally built into the terminal face (for example by machining, welding, forging, stamping, electropolishing or other metalworking methods) for immediate cell building. The corrugated piece is preferably of a light metal like aluminum having good conductivity and may be perforated to save weight.

To attain good cell stack compactness while allowing both good intercell electrical conductivity and intercell cooling, the corrugated pieces of adjacent cells may be made to nest compactly one within the other with bolting, screwing, clipping, pinning, crimping or welding together at the extremities. Wave-like corrugated sections allow for particularly good nesting with a high degree of interfacial conductive contact. Note that bolting or screwing together of adjacent cells in particular via the corrugated elements at their extremities allows facile removal of individual cells from the battery stack if necessary for replacement or maintenance, with welding and crimping less convenient alternatives. Pin, snap or clip connections may also be used but give a less reliable connection.

In one embodiment the stack of cells can be configured such that facile removal of cells (for example securing with bolts or screws) is enabled only once per several cells with the intervening cells more permanently secured via the corrugated interconnects using welding.

For compactness the distance between terminal faces of adjacent cells should be no more than 2 mm or no more than 20% of the cell thickness. Similarly there may be fixed only one corrugated unit between adjacent cells.

Instead of both halves of the cell having a tray shaped configuration with a peripheral insulating seal joining them, one side of the cell can be flat and the other half has the tray configuration for enclosing the anode and cathode elements. This is particularly important for lithium cell weight saving, since although the cathode support can be a light metal like aluminum, the (lithium) anode support is usually copper (for corrosion resistance), which is a heavy metal.

A weight saving strategy would be to use a plated or clad support for the anode, this clad element/support having externally a relatively thick layer of aluminum carrying a relatively thin layer of copper (for contact with lithium or other metals within the cell). Electroplated copper onto aluminum has the problem however that the plated layer may be porous or with pinholes and also that any welding operation may expose the underlying aluminum. Even a clad structure, which is pinhole free, can have limitations since, while forming a tray from a clad metal sheet, this can also expose the aluminum, as evident from typical stressful embossing or deep drawing procedures. The technique of the present invention thus utilizes flat clad sheet (for example copper clad aluminum) for the anode terminal of the cell to which the corrugated piece in this example is welded onto the external aluminum side. As discussed, the corrugated sections can alternatively be intrinsically formed on the terminal faces.

Additionally, according to an embodiment of the present invention, the bipolar battery arrangement has a C rate capability at least up to 20 C.

There is thus provided according to an additional embodiment of the present invention, a method for producing a semi-bipolar battery arrangement suitable for use in an electric vehicle including juxtaposing at least two monopolar battery units.

Additionally, according to an embodiment of the present invention, the method further includes constructing each of the monopolar battery units independently. This embodiment offers process advantages in the assembly of a bipolar stack since preselected cells with matched capacity can be assembled and there is the option to reject problematic cells before adding to the stack or following assembly. This is not feasible with regular bipolar stack assembly.

### BRIEF DESCRIPTION OF THE DRAWINGS

The invention will now be described in connection with certain preferred embodiments with reference to the following illustrative figures so that it may be more fully understood.

With specific reference now to the figures in detail, it is stressed that the particulars shown are by way of example and for purposes of illustrative discussion of the preferred embodiments of the present invention only and are presented in the cause of providing what is believed to be the most useful and readily understood description of the principles and conceptual aspects of the invention. In this regard, no attempt is made to show structural details of the invention in more detail than is necessary for a fundamental understanding of the invention, the description taken with the drawings making apparent to those skilled in the art how the several forms of the invention may be embodied in practice.

In the drawings:

FIG. 1A is a simplified schematic illustration showing a vertical side cross-sectional view of two monopolar battery cells forming a semi-bipolar cell construction, in accordance with an embodiment of the present invention;

FIG. 1B is a simplified schematic illustration showing a vertical side cross-sectional view of two cells with a slightly different inner construction to FIG. 1A, in accordance with an embodiment of the present invention;

FIG. 1C shows a jelly roll construction of anode and cathode within an individual cell of FIG. 1A or FIG. 1B, in accordance with some embodiments of the present invention;

FIG. 1D shows a Z-fold construction of anode and cathode within an individual cell of FIG. 1A or FIG. 1B, in accordance with some embodiments of the present invention.

FIG. 1E shows a stacked construction of anode and cathode planar elements within an individual cell of FIG. 1A or FIG. 1B, in accordance with some embodiments of the present invention.

FIG. 2 is a simplified schematic illustration showing a vertical cross-sectional view of two monopolar battery cells and their combination to form a three-dimensional semi-bipolar stack, in accordance with an embodiment of the present invention;

FIGS. 3A-3C are simplified schematic illustrations of combination methods of monopolar battery cells to form semi-bipolar stacks in accordance with embodiments of the present invention;

FIG. 4 is a simplified flow chart of a method for producing a monopolar cell of FIG. 1, in accordance with an embodiment of the present invention;

FIG. 5 is a simplified flow chart of a method for producing a semi-bipolar battery stack, in accordance with an embodiment of the present invention;

FIG. 6A is a simplified schematic illustration of an assembly of three adjacent cells separated by fixed corrugated elements, in accordance with an embodiment of the present invention;

FIG. 6B shows is another simplified schematic illustration of an assembly of three adjacent cells, spaced apart by bonded-on separating elements, in accordance with an embodiment of the present invention;

FIG. 7A is a simplified schematic three-dimensional exploded illustration of a monopolar battery cell, in accordance with an embodiment of the present invention;

FIG. 7B is a simplified schematic three-dimensional illustration of a monopolar battery cell, in accordance with an embodiment of the present invention;

FIG. 7C is a simplified schematic illustration of a side view of the monopolar battery cell of FIG. 7B, in accordance with an embodiment of the present invention;

FIG. 7D is a simplified schematic illustration of a side view of a semi-monopolar battery cell with current collector extensions, in accordance with an embodiment of the present invention;

FIG. 7E is a simplified schematic illustration of a side view of four corrugated connectors, in accordance with some embodiments of the present invention;

FIG. 8A is a simplified schematic illustration of a vertical cross section of a battery assembly with five cells interconnected via corrugated cell interconnections, in accordance with an embodiment of the present invention;

FIG. 8B is another simplified schematic illustration of a vertical cross section of a battery assembly with five cells interconnected via corrugated cell interconnections, in accordance with an embodiment of the present invention;

FIG. 9A is a simplified schematic illustration of a vertical cross section of two monopolar battery cells with current collector extensions and a corrugated interconnector, in accordance with an embodiment of the present invention;

FIG. 9B is a simplified schematic illustration of a vertical cross section of the two monopolar battery cells with current collector extensions and the corrugated interconnector after welding together to form a semi-bipolar battery in accordance with an embodiment of the present invention;

FIG. 9C is a simplified schematic illustration of a vertical cross section of a semi-bipolar battery assembly comprising five cells of FIG. 9B and cooling means, in accordance with an embodiment of the present invention;

FIG. 10A is a simplified schematic illustration of a vertical cross section of two monopolar battery cells with current collector extensions and another corrugated interconnector, in accordance with an embodiment of the present invention;

FIG. 10B is a simplified schematic illustration of a vertical cross section of the two monopolar battery cells with current collector extensions and the corrugated interconnector after welding together to form a semi-bipolar battery, in accordance with an embodiment of the present invention;

FIG. 10C is a simplified schematic illustration of a vertical cross section of a semi-bipolar battery assembly comprising five cells of FIG. 10B and cooling means, in accordance with an embodiment of the present invention;

FIG. 11 is a simplified schematic illustration of a horizontal cross section of FIG. 10C, in accordance with an embodiment of the present invention;

FIG. 12 is another simplified schematic illustration of a horizontal cross section of FIG. 10C, in accordance with an embodiment of the present invention;

FIG. 13A is a simplified schematic three-dimensional exploded illustration of a monopolar battery cell with a flat clad metal anode section and showing a embossed tray cathode section with a flange for placement of a sealing member, in accordance with an embodiment of the present invention;

FIG. 13B is a simplified schematic three-dimensional exploded illustration of an embossed cathode section used to fabricate a sealed monopolar battery cell with a flat clad metal anode section, in accordance with an embodiment of the present invention;

FIG. 13C is a simplified schematic two-dimensional illustration of a monopolar battery cell with a flat clad metal anode section, in accordance with an embodiment of the present invention;

FIG. 13D is another simplified schematic two-dimensional illustration of a monopolar battery cell with a flat clad metal anode section and crimp sealing, in accordance with an embodiment of the present invention;

FIGS. 14A-14E illustrate elements of a battery cell unit according to embodiments of the present invention, FIGS. 14A and 14B illustrate structures of the first metallic enclosure, FIG. 14C illustrates a structure of a sealing gasket. FIG. 14D shows a layer structure of an embodiment of the sealing gasket and FIG. 14E shows a second metallic case cover with applied sealing gasket;

FIGS. 15A-15B illustrate a sealing layer applied on the case cover according to some embodiments of the invention;

FIGS. 16A-16E illustrate battery cell configuration with external terminals (FIGS. 16A-16B), with corrugated metal cell interconnect (FIGS. 16C-16E) and a battery assembly according to some embodiments of the invention;

FIGS. 17A-17C illustrate embossed battery case enclosure with a centrally located circular thinner section providing venting means in a wall of the enclosure according to some embodiments of the invention;

FIG. 18A is a simplified schematic two-dimensional exploded cross-sectional illustration of a cell and its corrugated pieces (before attachment to the cell) that are to act as multifunctional cooling and cell electrical interconnection fins, in accordance with an embodiment of the present invention. In this case the corrugated pieces are shown as having a square turreted profile, other corrugation types can be used such as corrugations with the wave-like profile of FIG. 7E;

FIG. 18B is a simplified schematic two-dimensional cross sectional illustration of a cell showing fixed corrugated elements (that were welded onto the terminal faces before cell assembly or supplied as corrugations integrally part of the terminal faces) in accordance with an embodiment of the present invention;

FIG. 18C is a simplified schematic two-dimensional cross-sectional illustration of two adjacent cells juxtaposed such that the corrugated elements of each cell nest one within the other and the corrugated elements are bolted together at their extremities, in accordance with an embodiment of the present invention;

FIG. 19 is a simplified schematic two-dimensional illustration of four cells showing corrugated elements, in accordance with an embodiment of the present invention;

FIG. 20A is a simplified schematic two-dimensional illustration of a 7 cell semi-bipolar unit showing single corrugated cooling elements between adjacent cells;

FIG. 20B is a simplified two dimensional schematic of a single cell showing dimensional parameters;

FIG. 20C is a simplified three dimensional schematic of a seven cell semi-bipolar unit showing additional dimensional parameters;

FIG. 21 is a simplified three dimensional exploded illustration of a cell cathode tray section, its flat clad anode section and its corrugated cooling fin; and

FIGS. 22A-22B show a simplified three-dimensional schematic illustration of a six cell semi-bipolar unit that includes a cooling fan.

In all the figures similar reference numerals identify similar parts.

### DETAILED DESCRIPTION OF PREFERRED EMBODIMENTS

In the detailed description, numerous specific details are set forth in order to provide a thorough understanding of the invention. However, it will be understood by those skilled in the art that these are specific embodiments and that the present invention may be practiced also in different ways that embody the characterizing features of the invention as described and claimed herein.

By the term semi-bipolar battery unit (also could be described as quasi-bipolar or pseudo-bipolar) is meant that the corresponding battery unit is configured such that opposing surfaces of an enclosure of the battery unit provide positive and negative terminals thereof. More specifically, the battery unit is configured with one outer face that is the anodic cell terminal electrically connected to an anode active material directly or through a supporting structure. One other face of the same cell is the cathodic cell terminal electrically connected to a cathode active material directly or through a supporting structure. When two of these cells are juxtaposed, anode and cathode active materials may be in contact across the (electrically connected) intervening walls similar to the situation in a regular bipolar construction.

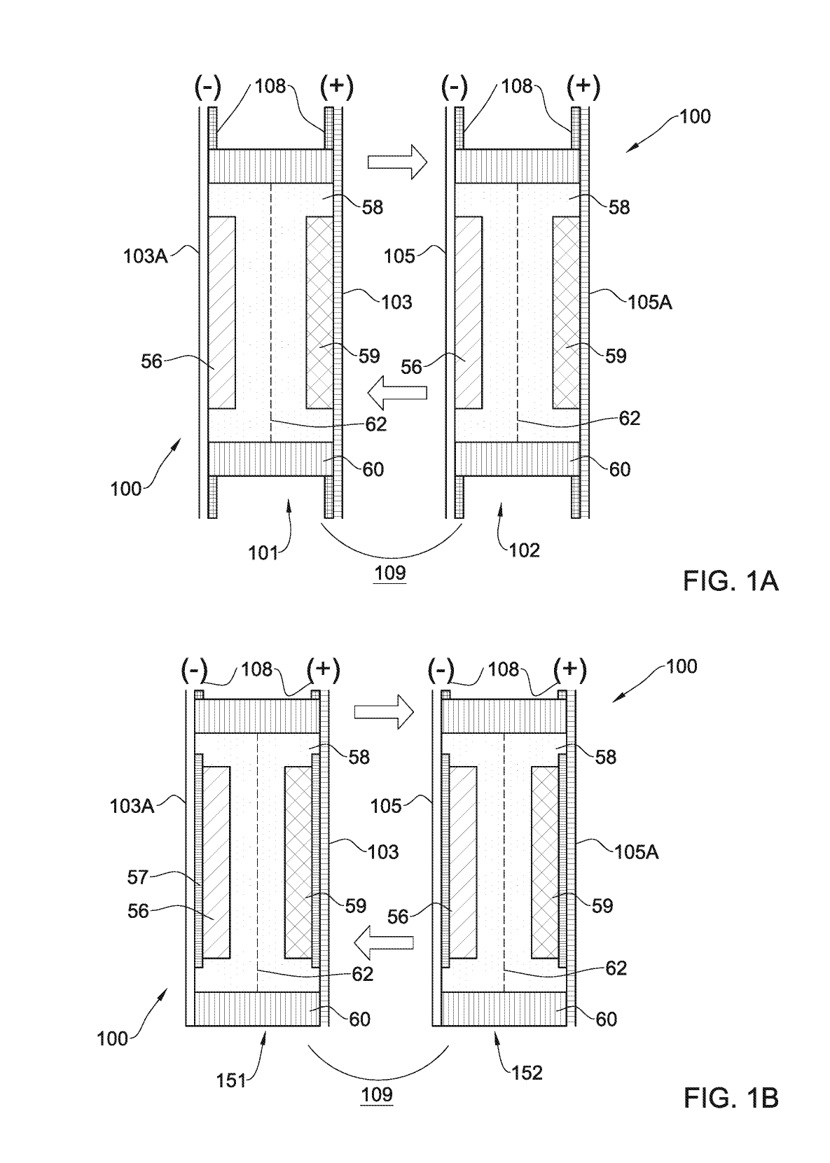

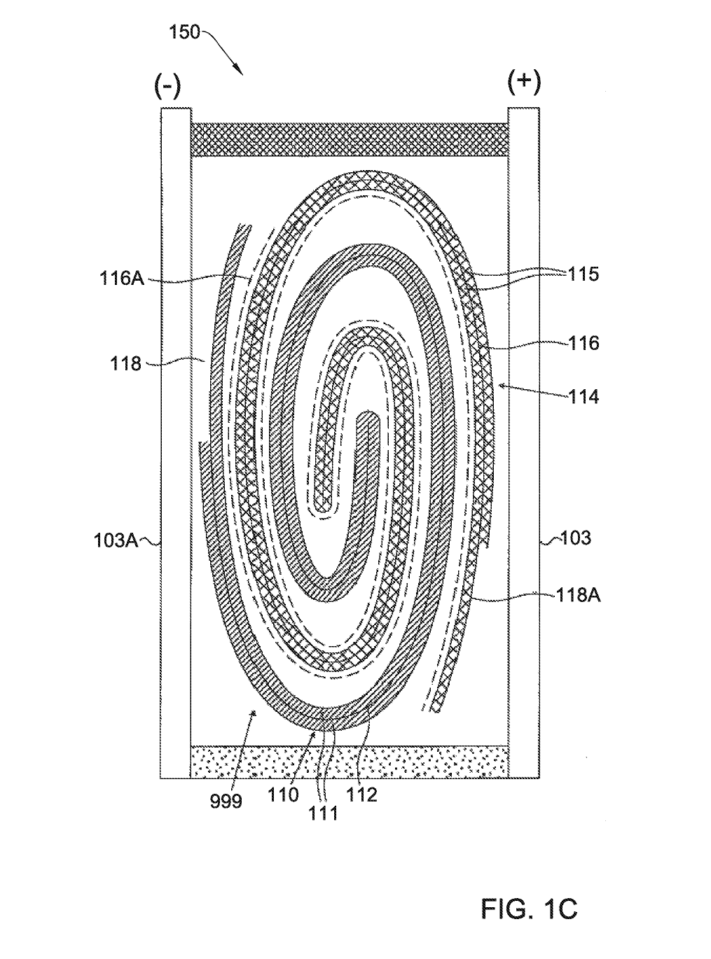

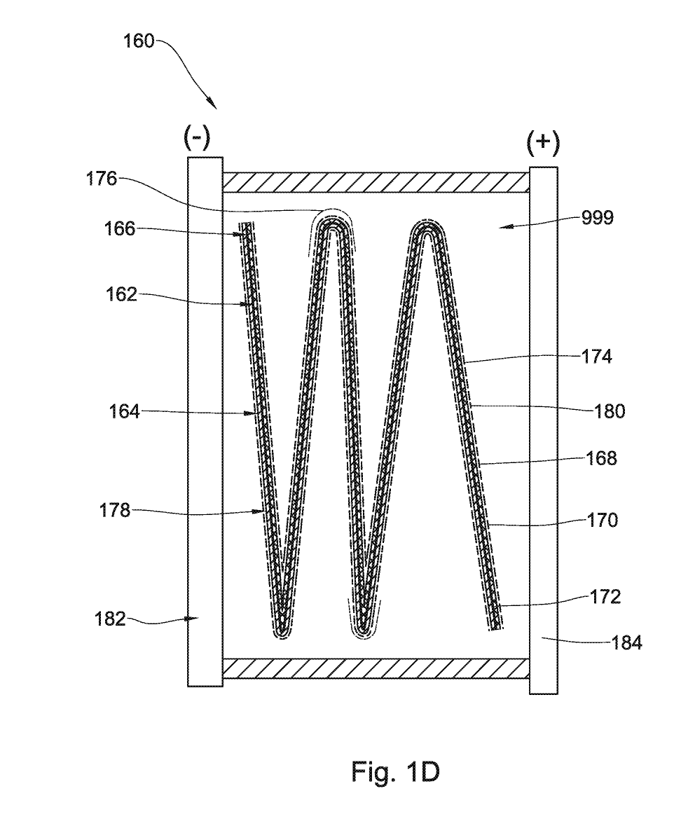

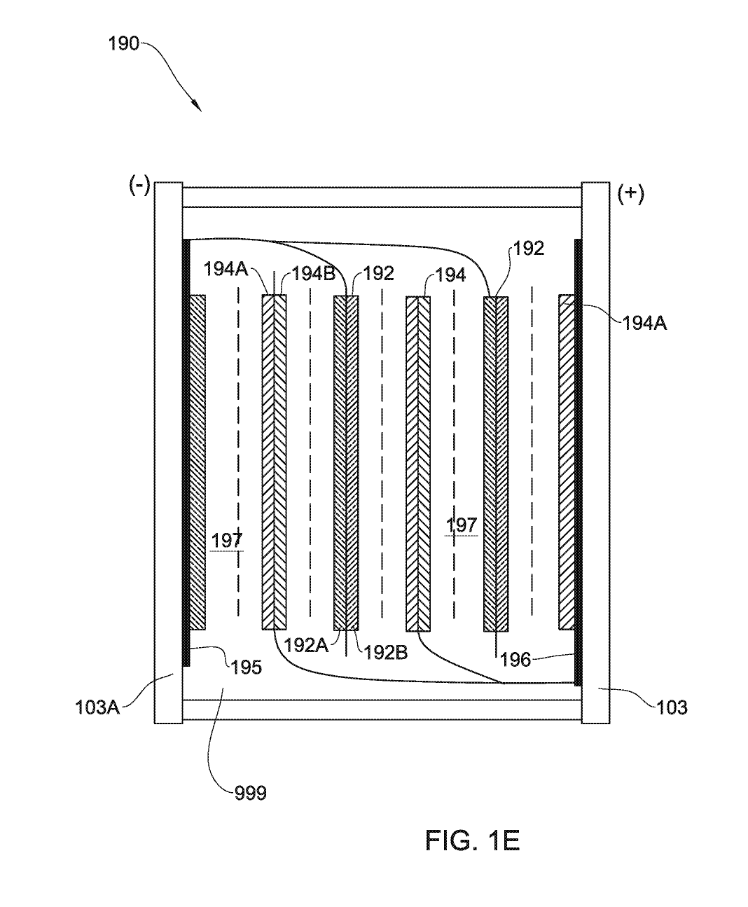

In this connection, reference is made to FIGS. 1A-1E exemplifying the concept of semi-bipolar battery cells and battery assemblies. FIGS. 1A and 1B are simplified schematic illustrations of two battery units 101, 102 (and 151, 152), forming a semi-bipolar cell construction 100, in accordance with an embodiment of the present invention. FIGS. 1C-1E schematically illustrate several battery unit configurations and shows anode and cathode active elements within the cell 150, 160 and 190.

FIG. 1A illustrates battery cells 101 and 102 configured as standalone cells with appropriate end foils (or sheeting) 103 and 103A (105 and 105A for cell 102) providing external terminals and configured for contacting internally the respective anode and cathode active materials. Cells 101 and 102 are configured to be juxtaposed together (connected in series) to give a semi-bipolar battery assembly 100 as shown. In the battery assembly 100, cathode wall 103 of cell 101 is in electrical contact with anode wall 105 of cell 102 thereby forming a combined electrode 109. The battery cells 101 and 102 also include end foils 108 projecting from the cell enclosure and configured to provide monitoring of the cell for balancing purposes. The end foils may be used for temperature monitoring or for additional parameters of the cell. The end foils 108 are generally coated on their inner surfaces (or a major portion of the projecting foil, not shown) with an insulating layer to prevent shorts. It should be noted that the end/sensing foil 108 may or may not be used in a battery cell unit and may be of a minimal length as shown e.g. in FIG. 1B.

Also shown in the figures, each of the battery cell units include anode 56 and cathode 59 active materials respectively directly connected to the negative 103A or 105 and positive 103 and 105 terminals of the battery cells. The anode 56 and cathode 59 active elements are electrically separated from each other by separator 62 while allowing ion transfer through an electrolyte 58.

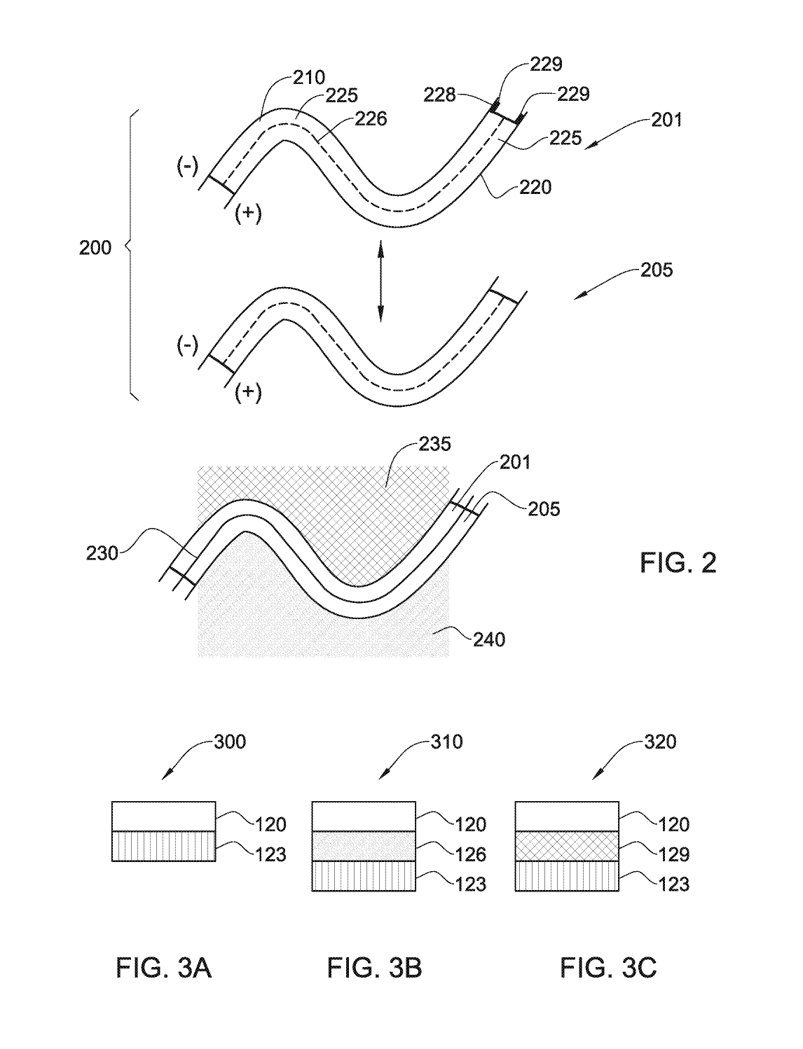

The two monopolar battery cells 101, 102, are constructed and configured to enable use in electric vehicles (see examples hereinbelow). The construction of these cells and those in FIG. 2 are configured for high power, large area and enable non-flexible and flexible semi-bipolar assemblies.

As shown in FIGS. 1A and 1B the battery cell units 101 and 102 (151 and 152) may be configured such that the active elements of the anode and cathode 56 and 59 are in direct contact with the cell enclosure as in FIG. 1A or using suitable support elements 57 and 59A as shown in FIG. 1B.

The anode and cathode support elements may be mesh, foam, foil or any other electrically conducting connecting member configured for bonding the active elements to the external terminals of the battery. It should be noted that the active elements may be welded to the enclosure at designated locations to provide increased electrical conductivity and reliability of the battery.

It should be noted that the underlying concept of the battery assembly of FIGS. 1A and 1B relies on the fact that when the battery cells are juxtaposed, the positive terminal of one of the battery cells is the positive terminal of the assembly and the negative terminal of the cell on the other side of the assembly is the negative terminal of the assembly. In this non limiting example terminal 103A becomes the anode end foil (terminal) and 105A becomes the cathode end foil of the assembly.

Reference is now made to FIGS. 1C to 1E illustrating a battery cell 150 having a jelly roll with anode 110 and cathode 114 configuration (FIG. 1C), and similarly a cell 160 having a Z-fold (FIG. 1D) and a cell 190 having stacked planar configuration (FIG. 1E). These configurations of the active elements of a battery cell allow better usage of the inner volume of the battery cell and thus provide higher capacity. It should be noted that according to the present invention, the inner configuration of the active elements may be of jelly roll type, Z-fold type, stacked planar type or any other type in accordance with the desired use of the battery units.

As shown in FIG. 1C, the anode 110 includes active anode material 111 on both sides of an anode current collector 112. Similarly the cathode 114 includes cathode active material 115 on both sides of cathode current collector 116. Anode 110 and cathode 114 are rolled up into a jelly roll assembly with separator 116A between them. Since anode and cathode may preferably be welded to the inner faces 103A and 103 of the battery cell, a portion 118 of the anode current collector and an end portion 118A of the cathode current collector is left un-pasted with active material on its outer face to enable good welding with cell walls 103 and 103A. It should be noted that the jelly roll (or its constituent anode and cathode current collectors) may be fitted with additional conductors along its length, or as side contactors (not shown), that can be also welded to the respective cell walls (not specifically shown). When the anode and cathode current collectors are welded to the cell walls, the battery cell is partially sealed and filled with electrolyte 999 (suitable aqueous or non-aqueous electrolyte depending on the battery chemistry). After additional steps such as electrode formation the battery cell may be sealed.

In the example of FIG. 1B, only one material is applied to each current collector (of the anode or cathode active elements). This may be the case in e.g. lithium-ion cells. This provides various advantages over conventional bipolar battery stacks, where electrolyte is generally added to the battery cells one by one and each region/cell is sealed one at a time. This increases the complexity of production and may cause capacity anomaly or misalignment which might be difficult to undo. This is while the battery cells according to the present invention provide standalone configuration of each battery cell as a complete sealed unit. Thus the different cells may be easily matched, checked and stacked or replaced if required.

Referring back to FIG. 1D, this figure exemplifies a battery cell 160 having a Z-fold construction of the anode 162 and cathode 164 within the battery cell. In this configuration the anode 162 comprises active anode material 164 on one side of anode current collector 166 and a cathode 168 comprises cathode active material 170 on one side of cathode current collector 172. The anode 162 and cathode 168 are folded on a mandrel into a Z-fold assembly with active materials facing each other and separator 174 between them. Additional separator sections 176 may also be used.

The outer faces of the anode and cathode current collector 178, 180 may generally be welded to the inner terminal faces 182 and 184 of the semi-bipolar battery cell. This may provide higher quality connection between the active elements and the external terminals of the battery cell. It should be noted that to provide best quality welding, the outer sections of the anode and cathode facing the terminal walls should left bare (not shown) of the active material. It should be noted that such welding may be performed not only in the shown Z-fold configuration but also in jelly roll and stacked planar configurations or in any other electrode configuration of the battery cell. In some embodiments of the present invention, the anode and cathode active elements may be fitted with additional conductors configured along the electrodes or as side contactors (not specifically shown). The additional conductors may also be welded to the respective cell inner walls to provide stability and reliable conductance. Once this welding is completed the cell can be partially sealed, filled with electrolyte 999 (suitable aqueous or non-aqueous electrolyte depending on the battery chemistry), and after additional optional formation steps are performed, the filling port may be sealed and the battery cell may be ready for use.

Somewhat similar configuration is shown in FIG. 1E, illustrating a monopolar battery cell 190 having a stacked planar construction of planar anode elements and planar cathode elements fitted with separators within a battery cell. Such stack planar configuration may provide greater capacity per cell while maintaining simplicity of the cell production and structure. The inner positioned anodes 192 comprise active anode material 192A on both sides of anode current collectors 192B and the inner positioned cathodes 194 comprise cathode active material 194A on both sides of cathode current collectors 194B. Outer anode 195 and outer cathode 196 carry active material only on their inner face. Anodes and cathodes are stacked with separators 197 between them and then anode and cathode current collectors are welded inside the cell to respective cell anode and cathode terminal faces 103A, 103 of the semi-bipolar cell.

Similarly to the Z-fold or jelly roll configurations, once electrodes are welded to the cell walls, the cell can be partially sealed, filled with electrolyte 999 (suitable aqueous or non-aqueous electrolyte depending on the battery chemistry), required electrode formation steps conducted, followed by completion of sealing.

Reference is now made to FIG. 2, illustrating a simplified schematic vertical cross-section view of two monopolar battery cells and their combination to form a three-dimensional semi-bipolar stack 200 (with an optional spacing element (not shown), in accordance with some embodiments of the present invention. FIG. 2 shows combination of two long standalone cells into a three-dimensional S-shaped semi-bipolar stack (other geometries possible), with appropriate end sections that maintain the stack geometry in a rigid, compressed S-shape and allow good high current takeoff from the outer cell foils.

As shown, two similar flexible standalone cells 201 and 205, each configured with an anode foil 210 (preferably copper or aluminum clad with copper may be used in the case of a high voltage lithium cell) that contacts anode active material 215 in the cell, and a cathode foil 20 (preferably aluminum) that contacts cathode active material 225 in the cell. The active materials are separated by a separator 226, while the cell contains electrolyte and is edge sealed 227 at the periphery. The cell may include projecting foils 228 at each side acting as terminals for voltage, temperature monitoring and cell balancing. The inner faces of foil projections 228 or a major portion of those projections (not shown) are covered with an insulator 229 to prevent shorts. The two cells 201 and 205 are juxtaposed as shown in the lowermost section of the Figure in an S-shaped topology observing polarities to give a series connected semi-bipolar assembly. The cells are in electrically conductive contact along line 230 using direct contact, conductive adhesive or a conducting interlayer such as a metal, graphite, carbon conducting polymer or polymer with conducting filler in sheet or foam form.

It should be noted that although the battery cells of FIG. 2 are shown as being in direct contact between them, for example where cooling is not an issue, the present invention provides a corrugated conducting connector located between adjacent battery cells to provide electrical conductivity between the cells while allowing a flow of air or other cooling fluids.

The above configuration of the battery cells according to the present invention may provide robust conductive end sections 235 and 240 for the anode and cathode respectively; allowing high current takeoff with reduced resistivity. The end plates at each side of the semi-bipolar stack may be constructed, according to some embodiments, out of an adequately conductive metal. This may include an additional current takeoff sheet supported by a light rigid plastic frame (not shown). Additionally, a temperature-triggered resistive component (TTRC, not specifically shown) may be included on an electrically conductive sheet. The TTRC may be for example a polymerizing plastic in the sheet or layer and may be configured to greatly increase the resistance between cells in the case of battery overheating to reduce battery explosions due to heating. Generally the TTRC electrically isolate an overheated individual cell.

The end-sections of the battery cells may be used to keep the cells clamped rigidly in the S-shape configuration and are preferably open-celled metallic structures (preferably from aluminum) to save weight. It should be clear that this S-shape configuration (which allows considerable increase of individual cell area, cell capacity and current output in a compact manner) cannot be built up using a conventional prior art bipolar construction.

Reference is made to FIGS. 3A-3C showing simplified schematic illustrations of combination methods of monopolar battery cells to form semi-bipolar stacks 300, 310 and 320, respectively, in accordance with an embodiment of the present invention. FIG. 3A shows a foil 120 configured to support the anode active material of one cell (not shown) and foil 123 supports the cathode material of the adjacent cell (not shown) with the two foils in pressed contact providing electrical connection between the two adjacent battery cells. FIG. 3B shows the two foils being bonded by a conducting adhesive layer 126. Examples of the adhesive are epoxy, acrylic or silicone and the conductive filler may be a powder selected from carbon, graphite, ceramic or metal. In a double foil semi-bipolar unit the foil thicknesses may be reduced so as not to increase greatly the weight over a single metal bipolar plate. In FIG. 3C, the adjacent battery cells are physically separated by a corrugated metal spacer 129 providing electrically conductivity between the adjacent battery cells while allowing flow of cooling fluid (e.g. air or other cooling material) between the battery cells. It should be noted that the corrugated metal spacer may generally be configured as a thin spacer and is configured to provide plurality of contact points with the battery cell terminals. The corrugated metal spacer 129 may be welded to the battery cell terminals at several locations of the contact points or at all of the contact points.

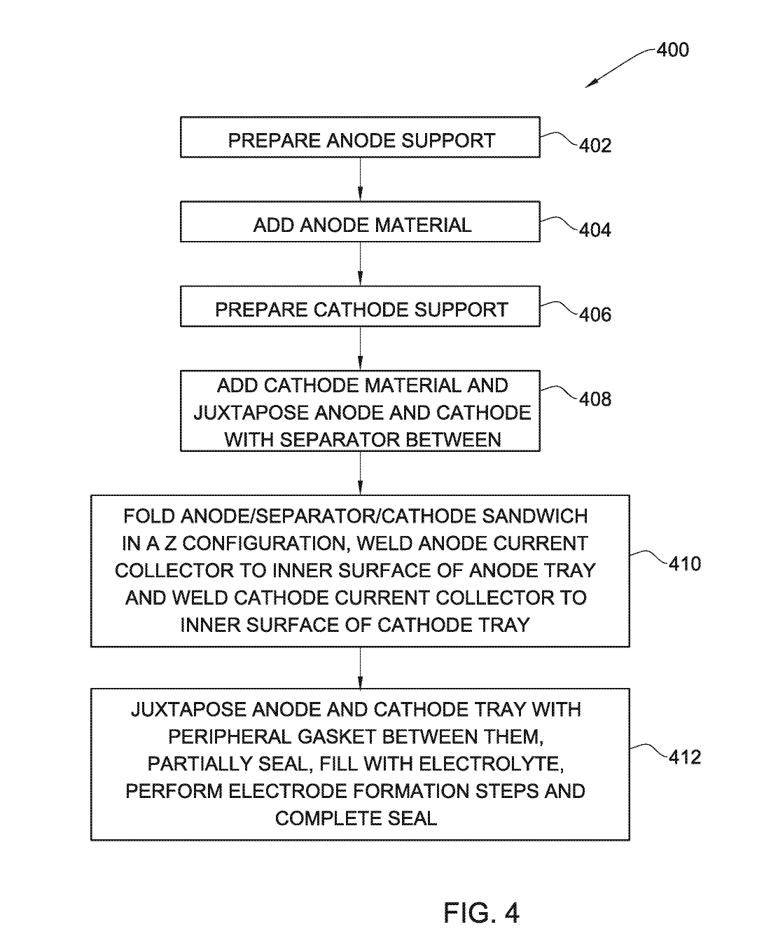

Reference is now made to FIG. 4, which is a simplified flow chart 400 of a method for producing a monopolar battery cell, e.g. battery cells 101 or 102 of FIG. 1A, in accordance with some embodiment of the present invention. It should be understood that the order of the steps may be changed, reversed, run in parallel, according to some embodiments of the present invention. In a first preparing step 402, a first electrode support element layer (105 or 103) is formed. According to some methods, the first step may be for preparation of the anode support element layer 105. Conversely, the first step may be the preparation of the cathode support element layer 103. This step may be performed by any suitable method known in the art, such as metal deposition, electrolytic deposition, electroless deposition and the like.

For the purpose of exemplification and simplification only, flowchart 400 shows the preparation of the anode material step 404 before that of the cathode 408. Step 404 deposits anode active material 56 onto anode support element layer 105. This step may be performed by any suitable method known in the art, such as pasting, pressing, impregnating, screen printing, lithography, metal deposition, electrolytic deposition, electroless deposition, electrophoretic deposition and the like.

In a cathode material addition step 408, a cathode active material 59 is deposited onto cathode support element layer 103 prepared in step 406. This step may be performed by any suitable method known in the art, such as pasting, pressing, impregnating, screen printing, lithography, metal deposition, electrolytic deposition, electroless deposition, electrophoretic deposition and the like. The cathode and anode are juxtaposed with the separator between them to complete step 408.

The anode/separator/cathode sandwich is folded for example in a Z-configuration, the anode current collector is welded to the inner surface of the cell anode tray (cell anode terminal) and the cathode current collector is welded to the inner surface of the cell cathode tray (cell cathode terminal), completing step 410. Thereafter, in a sealing of at least one unit end step 412, a sealing and insulating material (such as a peripheral gasket) is introduced near to the ends of the enclosing tray elements to form the unit and sealed in place. In some cases, a first end may be sealed first and an electrolyte 58 added to the cell, required electrode formation steps conducted and thereafter, the second end is sealed 60. Further finishing steps such as insulating foil projecting edges, adding end foil current takeoff members, stack confining members, marking, labeling and packaging are omitted here for the sake of simplicity.

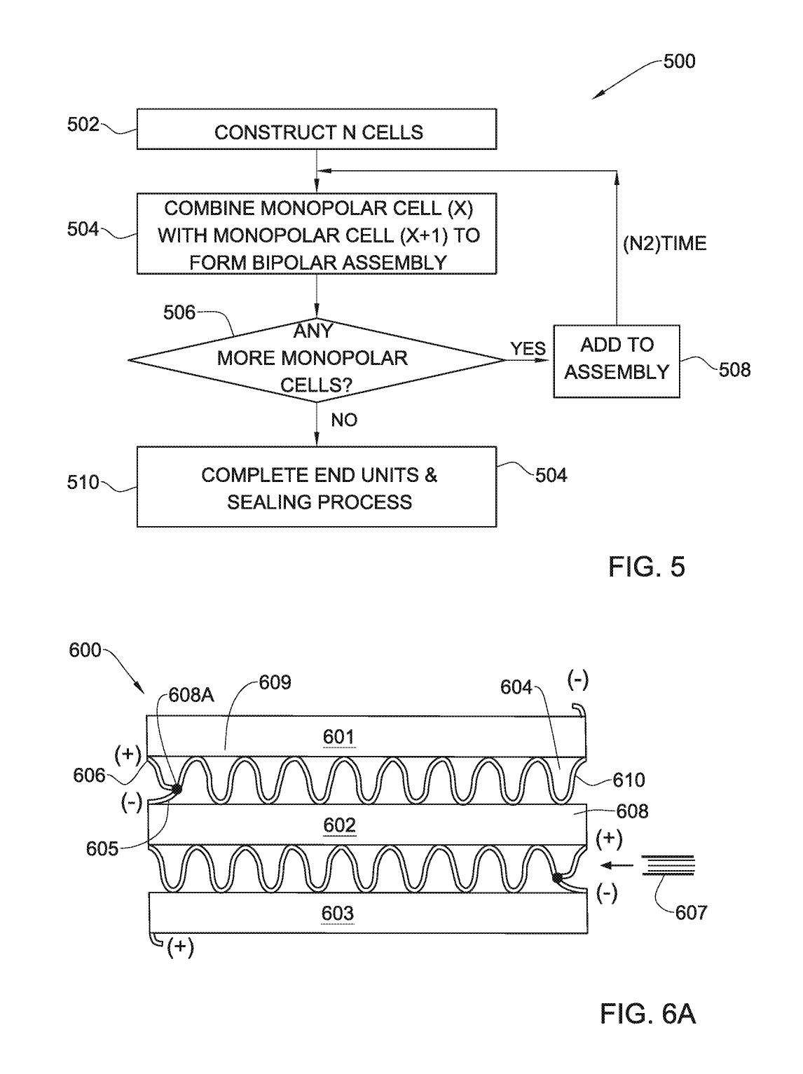

Reference is now made to FIG. 5, which is a simplified flow chart 500 of a method for producing a semi-bipolar battery stack in accordance with an embodiment of the present invention. In a monopolar cell (termed herein “unit”) construction step 502, monopolar cells, such as units 101, 102 (FIG. 1A) or cells 201 and 205 (FIG. 2) are constructed. One non-limiting example of the main construction steps is shown and described with reference to FIG. 4 hereinabove. In a cell combining step 504, the first cell, such as 101 is juxtaposed with a second cell, such as 102. This juxtaposition brings anode support element layer 105 of second cell 102 into proximity/contact with the cathode support element layer 103 of the first cell 101, thereby forming a semi-bipolar element 109. In a checking step 506, it is checked to see if there are any more cells to be juxtaposed. If no, then a completion step 510 is performed, in which end units (exemplified as 235 and 240, FIG. 2) are formed at the far opposing ends of the two cells. If yes, then addition step 508 is performed and a new cell is juxtaposed with either a far opposing end of the first cell 105 of cell 101 or 103 of cell 102, thereby forming another semi-bipolar element 109 (not shown). Thus for n cells, there are n−1 semi-bipolar elements 109. Additionally, it should be noted that for n cells, step 508 is repeated n−2 times. Ultimately after step 508 has been repeated n−2 times, step 510 is finally performed to complete the construction of the semi-bipolar battery assembly 100, 200. It should be understood that the sequence of the steps may be changed, reversed and, if possible, some may be run in parallel.

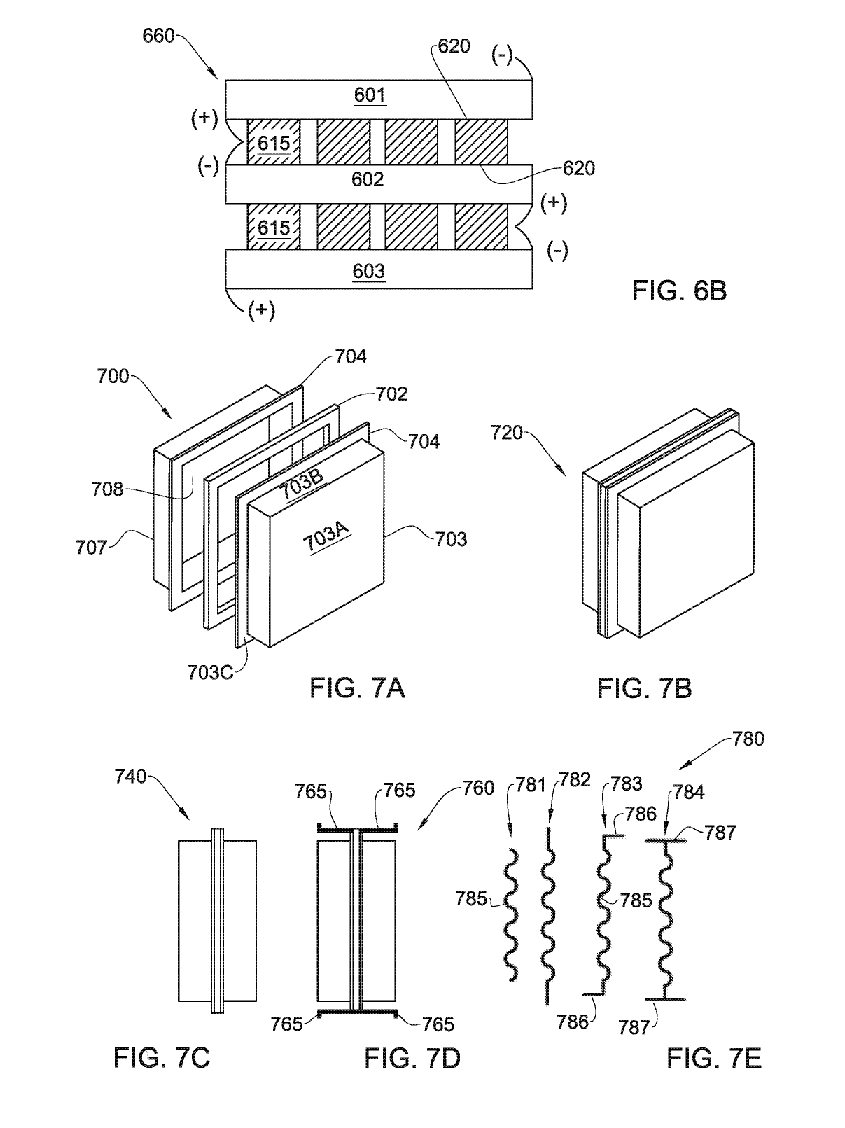

Reference is made to FIGS. 6A and 6B showing two simplified schematic illustrations of a vertical cross section of battery assemblies 600 and 660 of three adjacent cells 601, 602, 603, in accordance with embodiments of the present invention. Each of the battery cells 601, 602, 603 may preferably be configured according to the present invention as battery cell 100 of FIG. 1A, battery cell 100 of FIG. 1B or as will be described further below. It should also be noted that the internal active elements configuration may be that shown in any one of FIGS. 1C-1E or any other active elements configuration as known in the art.

As indicated, FIG. 6A shows a corrugated metallic element 610 which may be welded at a weld point 608A to bent-back terminal extension pieces 605, 606, providing spaces 604 between adjacent cells 601, 602, and 603. The metallic elements 610 (also called spacers herein) are configured to be electrically conductive and allow transmission of electrical current between cells while allowing inter-cell flow of cooling gaseous fluid 607 (using air, gaseous Freon or the like). Terminal extension pieces 605, 606 projecting from terminal faces 608, 609 are shown to be bent-back and may be welded to corrugated spacer 610, such that the cell interspacing and footprint are maintained. Additionally the spacer 610 is generally made to fit in the gap between adjacent cells such as 601, 602 and 603. The corrugated metallic element 610 may be a thin corrugated metal sheet, advantageously perforated (not shown) for weight saving and improved air passage. Some non-limiting options for the spacers are shown in FIG. 7E.

FIG. 6B illustrates another simplified example of an assembly 660 of three adjacent cells 601, 602, 603, spaced apart by plurality of bonded-on spacer elements or strips 615 in accordance with an embodiment of the present invention. The spacer elements may be constructed of electrically conductive material (e.g. metal foams, metal wool) and bonded or welded to cell walls at 620 (e.g. with conductive adhesive (not shown). Alternatively, the spacers as shown in FIG. 6A or 6B may be made of suitably conducting carbon compounds or conducting polymer (plastic).

Reference is now made to FIGS. 7A-7E illustrating a three dimensional configuration of a battery cell 700,720,740 and 760 unit and spacer connectors 781,782,783 and 784. FIG. 7A shows a simplified schematic three-dimensional exploded illustration of a battery cell 700, in accordance with an embodiment of the present invention. The battery cell 700 is configured of two half-cell cases 703, 707 made, for instance by an embossing or deep drawing step of a metal foil (e.g. aluminum) to give a tray-like case structure with a large area face 703A, a side section 703B and a rim 703C. The half-shell cases have a hollow interior space 708 for receiving a jelly roll anode/separator/cathode construction as in 150 FIG. 1C, a Z-fold construction as in 160 (FIG. 1D), or a stacked plate construction as in 190 (FIG. 1E) as well as electrolyte 999 (FIG. 1C). The two half-cell cases (also called hollowed elements) 703, 707 are constructed and configured to have a peripheral inner rim flange 704. Disposed between the two inner rim flanges is an insulation and sealing gasket 702.

Once the electrode active elements are introduced into the interior space, anode and cathode may be welded internally to the terminal faces. The two half cases are then joined together with a sealing gasket, between them electrolyte 999 is introduced into the space, any electrode formation steps conducted, followed by completion of the cell sealing. FIG. 7B shows a three-dimensional illustration of the exterior of the completed monopolar battery cell 720, in accordance with an embodiment of the present invention. In this connection, FIGS. 7C and 7D show side views of the battery cell 720 and 760. In the example of FIG. 7C the battery cell is configured such that flat interface of the half-shell cases act as positive and negative terminals of the battery cell. In the example of FIG. 7D each half-shell case includes an additional current collector extension 765 providing an additional electrical path between battery cells units.

FIG. 7E shows four simplified schematic illustrations of a side view of four connectors 781, 782, 783 and 784 in accordance with some embodiments of the present invention. These connectors are generally constructed of electrically conducting material and may preferably be good heat conductors, for example the connectors may be metallic, e.g. made of aluminum or any other selected conducting material. The conducting connectors 781 to 784 are preferably configured with corrugated portion 785 or in the form of a ladder (not specifically shown) to allow passage of cooling fluid (e.g. air) between the battery cells while maintaining close spacing between adjacent cells. The connectors are generally configured to provide electrical conductivity between battery cells while providing suitable spaces between the cells to allow cooling of the batteries. Generally the connectors are configured to have plurality of contact points with flat surface terminals of the battery cells. Additionally, the connectors may be configured with one or more single- or double-sided conductive end sections 786 and/or 787 to provide electrically conductive contacts with the current collector extensions 765 in accordance with configuration of the battery cells. It should be noted that the end sections 716 and 786 may be modified in accordance with the battery cell configuration, e.g. end sections of connector 783 may be modified to face the same direction.

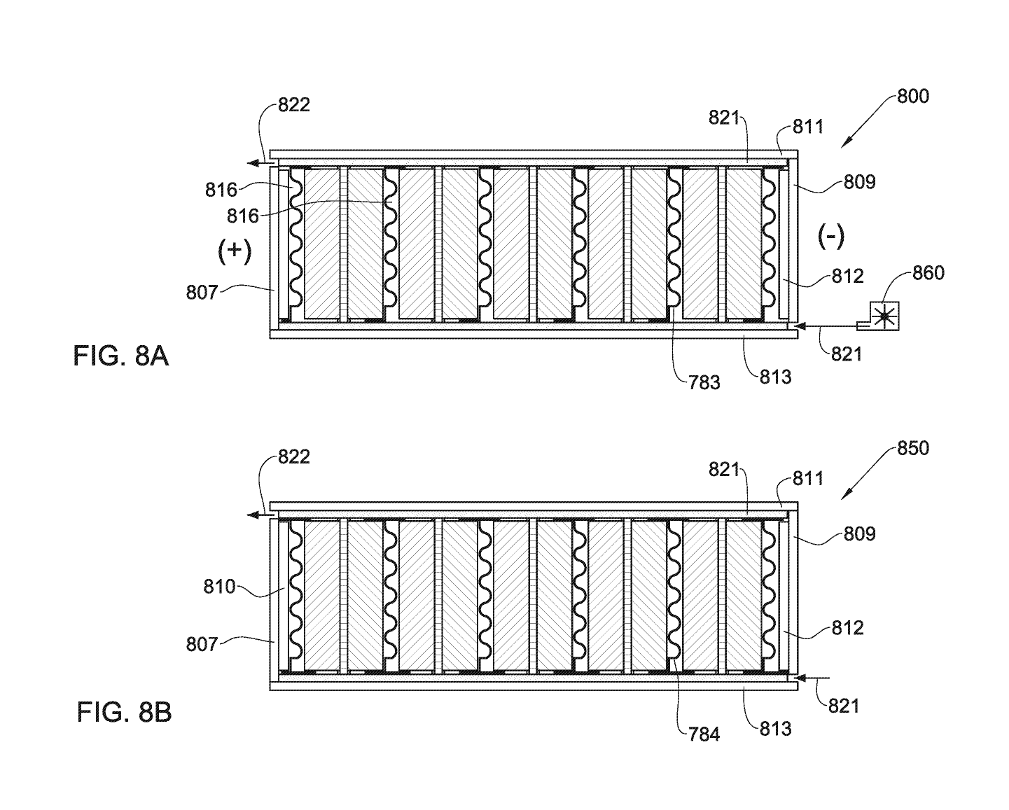

Reference is now made to FIGS. 8A-8B, showing simplified schematic illustrations of a vertical cross section of a battery assembly 800 and 850 configured with five battery cells 720 (e.g. as shown in FIG. 7B or as will be described further below) interconnected via corrugated cell interconnections 783 or 784 (FIG. 7E), in accordance with embodiments of the present invention. Battery assemblies 800 and 850 are shown having five cells 720 connected in series via six interconnections 783 or 784. It should be noted however that any number of cells is possible and that the end connections may be omitted in accordance with the desired use of the battery assembly. In these examples, each cell is disposed between two interconnections. The battery assemblies 800 and 850 also include two terminals 807 and 809, which may also serve as compression plates. Additionally, the battery assembly may include frame spacers 811, 813 for fine adjustment of the frame size. The battery assembly is preferably constructed and configured to provide high surface area for cooling as well as electrical transmission between battery cells to thereby enable high voltage and high load use. The battery assembly may also include a top frame 811 and lower frame 813 closing the battery assembly within a dedicated case. As shown, the spacer/interconnection 783 and 784 are configured as corrugated elements 785, or having a ladder form to provide numerous air spaces 816 (or channels) in between cell cases 703, 707. The air spaces between battery cells allow flow of gaseous cooling agent, such as air, introduced in between the battery cells (either in closed or open assembly configurations) for cooling. The cooling agents may be introduced into a closed assembly through an entry point 821 using a gaseous cooling fluid/agent blower 860 and pass via air spaces 816 to the gaseous cooling agent exit 822.

As is shown in these figures, the cell multi-functional interconnections 783 and 784 may be welded via single sided 786 or double sided 787 end sections to adjacent cells ensuring the electric connection and providing close spaced feed-through volume between cells for effective cooling/heat dissipation. It should be noted however that the interconnections may preferably be welded to side surfaces of the battery cells.

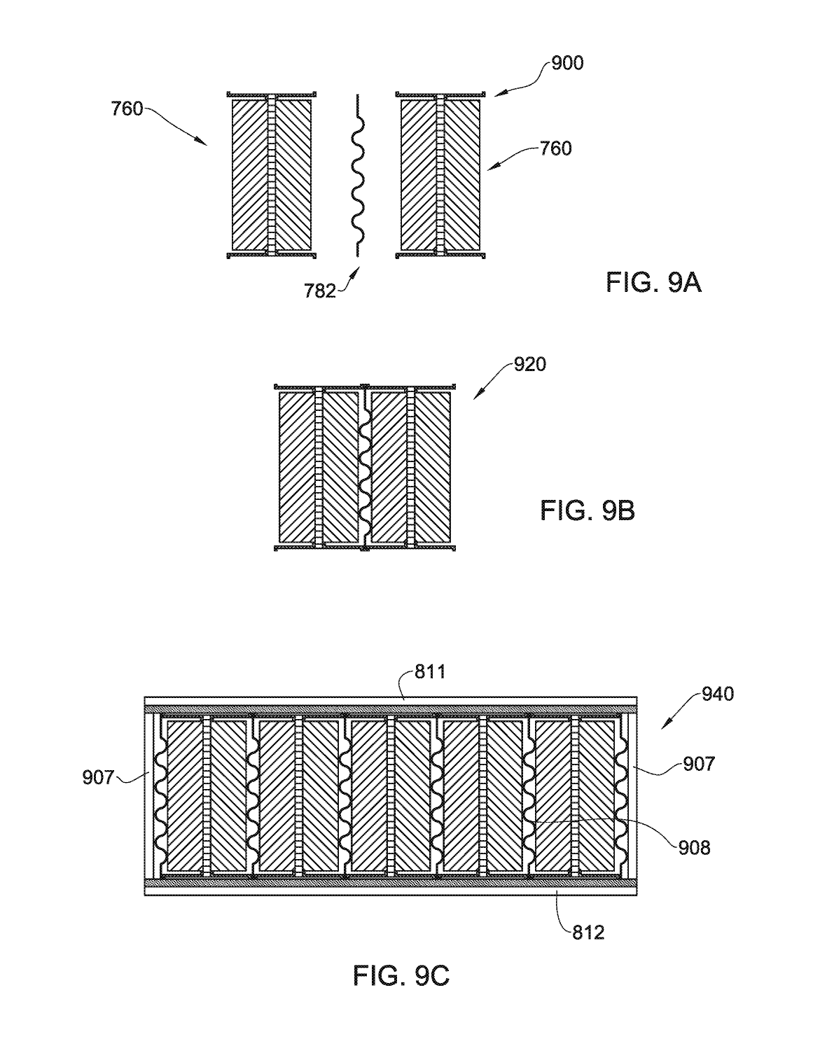

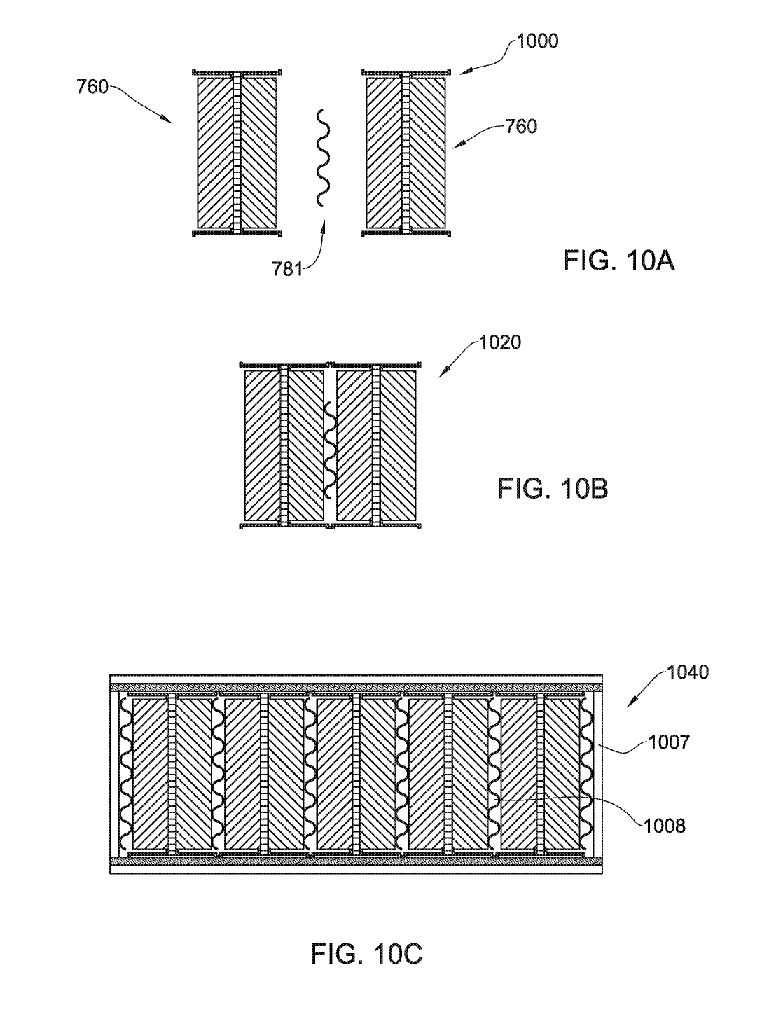

Additional configurations of a battery assembly are shown in FIGS. 9A to 9C and in FIGS. 10A to 10C. In FIGS. 9A-9C the battery assemblies show battery cells having current collector extensions 765 and are electrically connected between them by corrugated interconnectors 782 (FIG. 7E). The interconnections may be welded to the battery cell side surface and/or the current collector extensions.

In the examples of FIGS. 10A to 10C the battery cells are shown close placed with current collection extensions. However the interconnections 781 used are configured to provide electrical connection to the surface of the battery cells 760. Additionally, the battery cells 760 may or may not be configured with current collector extensions, which may provide an additional path for electric transmission between the battery cells.

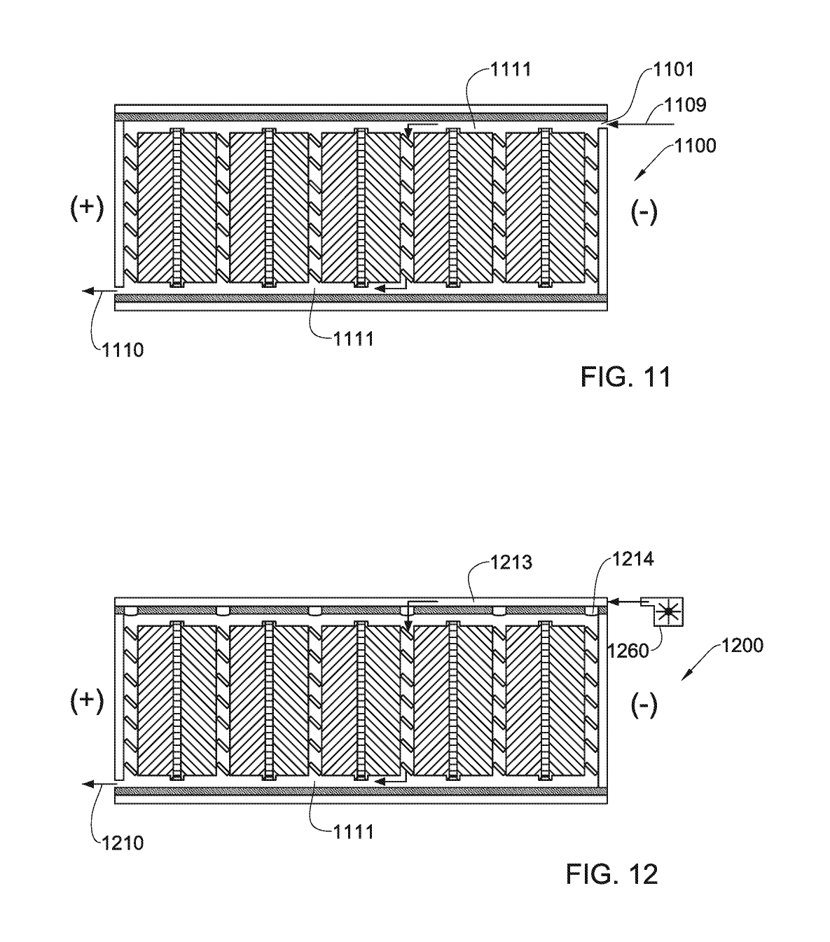

Reference is made to FIGS. 11 and 12 showing two simplified schematic illustrations of horizontal cross section of battery assembly 1100 or 1200 in accordance with an embodiment of the present invention.

The battery assembly 1100 as shown in FIG. 11 is constructed and configured to receive a cooling gaseous fluid 1109, such as air or any other suitable gaseous (non conductive) coolant. The fluid passes through one or more inlet channels 1101 at one side of the battery assembly. Then, the air passes between the close placed battery cells through spaces 1111 and through the spaces of the interconnections. The air then flows through one or more outlet channels to air exit 1110.

In the example of FIG. 12, the battery assembly 1200 further includes an external cooling conduit 1213, which is in fluid connection with the assembly via expansion nozzles 1214. This allows the introduction of the cooling fluid provided by a cooling fluid provision apparatus 1260 through the nozzles and through the spaces 1111 between the battery cells. The fluid exits through one or more outlet channels to fluid exit 1210.

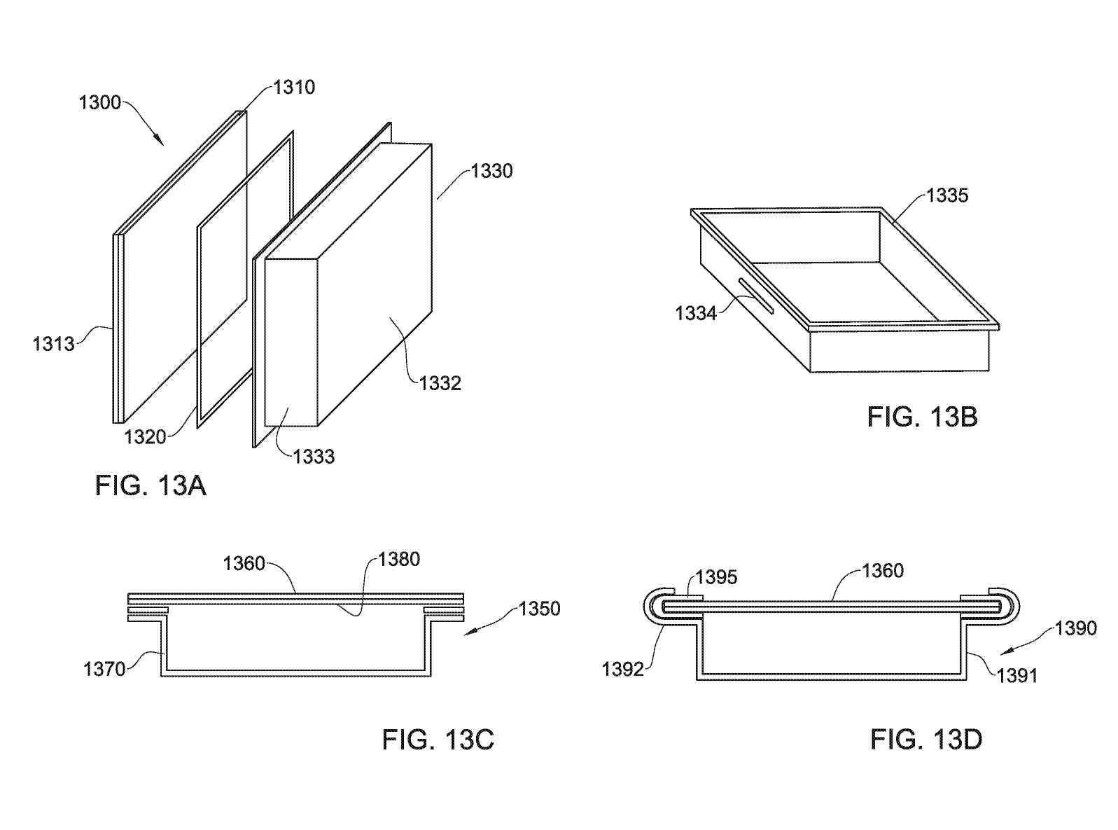

Reference is now made to FIGS. 13A to 13D schematically illustrating a battery cell unit configuration according to the present invention. FIG. 13A is a three-dimensional exploded illustration of a battery cell unit case 1300. The battery cell includes a first metallic enclosure 1330 having a base tray 1332 surrounded by walls 1333 to thereby define an inner volume thereof. Additionally the battery cell unit 1300 includes a second metallic case cover 1313 configured for closing the inner volume and defining the battery cell case. Between the first enclosure 1330 and the case cover 1313, the battery case generally includes a circumferential sealing material, 1320 which may be located along an interface between the first metallic case 1330 and the case cover 1313. The sealing material is configured to seal the battery case so that it is airtight and liquid tight and prevents electrolyte flow though gaps between the case elements. In some configurations, the sealing material may be a gasket pre-prepared in the form of the interface between the enclosure and the case cover. Additional adhesive layers may also be used as indicated with reference to FIG. 13C.

Generally, the inner volume includes anode and cathode elements separated between them by a separator (not specifically shown here), e.g. as shown in FIGS. 1A to 1E and FIGS. 3A to 3C or as generally known in the art. The anode and cathode elements and the separator are immersed in suitable electrolyte (e.g. electrolytic liquid) to allow exchange of ions between them and generate voltage between the anode and cathode elements. The anode and cathode elements in FIG. 13A are electrically connected to the metallic enclosure 1330 and metallic case cover 1313 such that one surface of the enclosure 1330 and the case cover 1313 respectively act as positive and negative terminals of the battery cell unit. Additionally, FIG. 13B shows a side top view of the first metallic enclosure showing the inner volume 1335 and a safety port or vent 1334 shown in this non limiting example as a linear scored section in the metal which may be provided on a side wall of the enclosure. The scored section may be a weakened region of the wall and may have an X or + shaped form (not shown). The safety port 1334 is provided to prevent explosion of the battery cell unit in case of overheating. When the battery is overheated, the electrolyte may expand and cause failure of the material around the safety port, thus limiting the leak to a defined location. As shown the battery case is configured with a rectangular shape, or it may be of any polygonal shape providing corners of the case. This is different than circular battery cases as commercially used in various applications such as watches or small electronic appliances. The rectangular (or any polygonal shape, or preferably square shape) allows for simpler use in large battery assemblies such as in electric or hybrid vehicles or in any other systems where the load is high and high capacity battery assemblies are needed.

FIGS. 13C and 13D show side views of two configurations of the battery cell units 1350 and 1390. In these figures the case cover 1360 is located on top of the enclosure 1370 and 1391 to close the battery case. As shown in FIG. 13C, the sealing material 1380 includes one or more adhesive layers used to bond the case cover onto the enclosure and thus seal the battery case. In the example of FIG. 13D, rim edges of the enclosure are crimped 1392 over the case cover 1360 to hold it tight in place. In this configuration, additional sealing material and/or adhesive 1395 may be applied at the crimping location to prevent short circuit between the enclosure and the case cover. It should be noted that as the battery enclosure is configured with polygonal (e.g. rectangular) shape, it has one or more corners where crimping may be challenging. Thus according to some embodiments of the present invention, the rim edges of the enclosure may be cut and not crimped to thereby provide one or more rim safety ports for the battery cell unit. It should be noted that the sealing material is preferably applied along a perimeter of the interface between the enclosure and the case cover including the safety port location to prevent leakage of the electrolyte during normal operation of the battery cell unit.

As also shown in FIGS. 13A to 13D, the case cover is flat and may be configured as a clad layered case cover, i.e. having a first layer of a first metal and a second layer of a second metal. The first and second layers may generally be of different thicknesses, for example with the thicker layer comprising a lightweight metal and the thinner layer providing corrosion resistance. For example the thinner layer could be some tens of microns and the thicker layer some fraction of a millimeter. Generally, the case cover may also be configured as a layered structure having at least a first layer of a first metal thermally coated by one or more additional layers of second (or more) metal.

This use of a clad structure can place a stable metal in contact with anode and/or cathode active materials within the battery cell and avoid corrosion. Generally, according to some embodiments, the first metallic enclosure/case may be formed of, or include, a first metal similar to the first metal of the case cover. In such configurations, the case cover is configured such that the first metal layer thereof is directed outwards with respect to the inner volume while the second metal layer is directed inwards and is in electrical contact with an active element within the battery cell (anode or cathode). For example in the case of lithium-ion cells, the first metal may be aluminum, which is relatively easy to work with and available in many electronic applications and packaging. The second metal may be copper providing a wide range of suitable anode-cathode materials for operation of the battery cell but is heavy and costly compared with aluminum. In this case a thin copper clad layer only will be in contact with the anode. It should however be noted that additional first and second metallic elements (being pure metallic elements or alloys) may be used in accordance with suitable electrochemistry of the cell. Furthermore the thickness of the copper cladding must be adequate to allow welding on of anode current collectors without exposing underlying aluminum.

Generally, the battery cell unit according to the present invention, either that of FIGS. 13A-13D or that of FIGS. 7A-7D may be configured such that outer surfaces of the battery case provide the positive and negative terminals of the battery cell. In this connection, the bottom tray of the first metallic case may be a first terminal of the battery cell and an external surface of the second metallic case cover is a second terminal thereof. Additionally, an insulating layer may be placed on side walls of the battery cell unit, including rim edges if present, to prevent electrical surges or short circuits due to contact with the side walls.

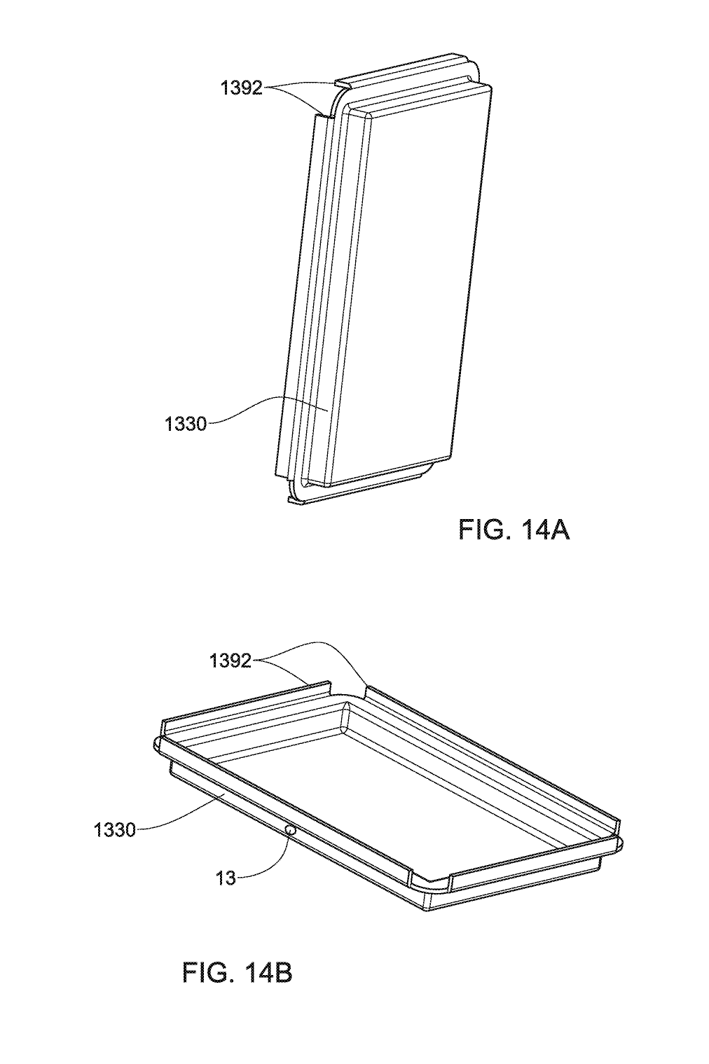

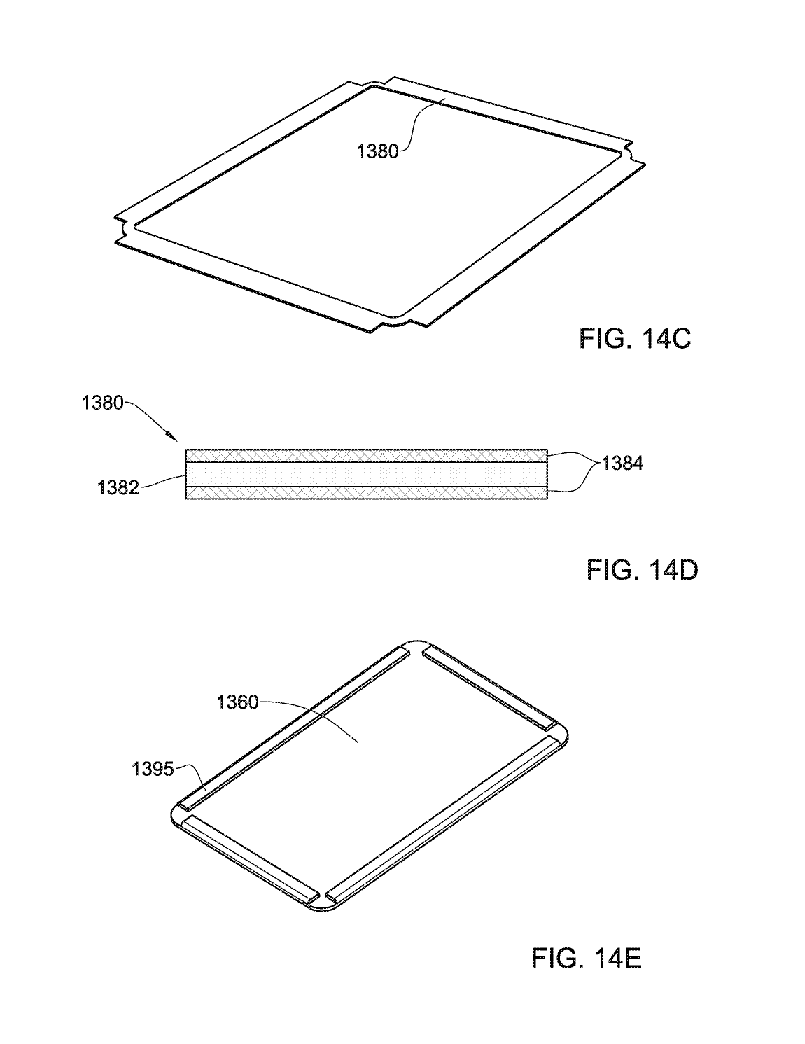

Reference is made to FIGS. 14A to 14E illustrating elements of the battery cell unit packaging according to some embodiments of the invention. FIGS. 14A and 14B show the first metallic enclosure 1330, configured as a one piece metallic enclosure embossed from a metal sheet. As shown, the metal enclosure may have a rectangular form with sharp or rounded edges and include a rim about the perimeter of the walls thereof. The rim also includes additional edges 1392 configured to be crimped over the case cover to provide tight closing to the battery cell unit. As shown, the rim edges are configured to be open at corners of the enclosure to simplify crimping at the corners as well as to allow pressure release through the corners in case of overheating of the battery cell (safety valve).

Also shown in FIG. 14B is a filling port 13 on a side wall of the metallic enclosure 1330. The filling port 13 may be used for pumping electrolyte solution into the battery cell after the electrodes and the case cover are attached to close the cell. For example, the battery cells unit may be assembled or placed after assembly is vacuum environment. Electrolyte solution may then be pumped into the cell, utilizing an external pump and/or the low pressure within the battery cell, the filling port 13 may then be sealed by crimping of a thin metal tube through which the electrolyte is provided. Additionally or alternatively the filling port 13 may be sealed by soldering or welding thereof.

FIGS. 14C to 14E show a gasket like sealing element 1380 in a top view (FIG. 14C), side view (FIG. 14D) and when applied on the case cover 1360 (FIG. 14E). The sealing material 1380 may preferably be designed in accordance with the rim structure of the enclosure 1330 (FIG. 14A) and configured to provide sealing to the cell unit both at the interface between the enclosure and the case cover and at the crimping regions on top of the case cover. Additionally, the sealing material may be a layered structure including a polymer based layer 1382 sandwiched between two adhesive layers 1384 on either side thereof as shown in FIG. 14D. According to some embodiments, the sealing gasket may be attached to the case cover 1360; edges 1395 thereof may be folded on top of the case cover 1360 to provide optimal sealing at the crimping locations, the edges 1395 may provide an adhesive washer, sealing the perimeter of the case. The case cover 1360 with the sealing gasket 1380 can then be placed on the enclosure 1330, sealing around the rims thereof, and the edges of the enclosure 1392 may be folded/crimped to provide tight closing to the battery cell unit.

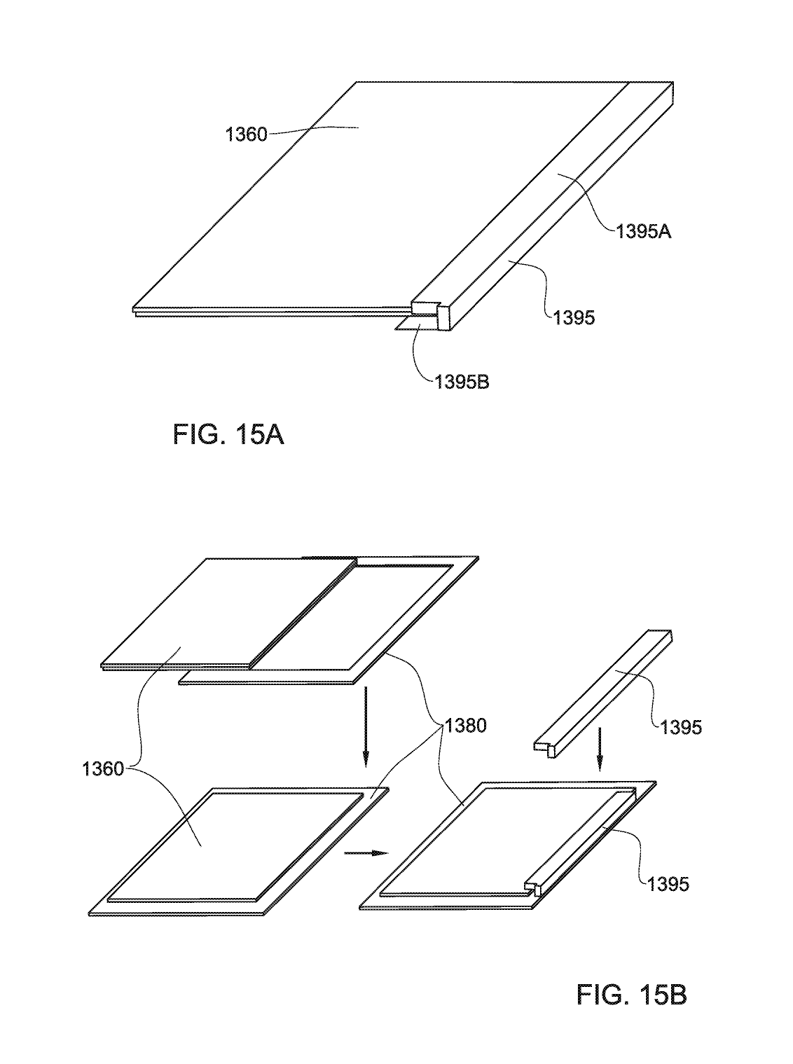

In this connection, FIGS. 15A and 15B illustrate a different configuration of the case cover 1360 and the associated sealing material. FIG. 15A shows a case cover 1360 and an adhesive washer element of the sealing material 1395. Differently from the example of FIG. 14E where the adhesive washer is a part of the sealing gasket 1380, in this example the adhesive washer of the sealing material 1395 is configured as a separate element. As shown in FIG. 15B, the case cover 1360 may be placed on a sealing gasket 1380. When the case cover is located in place, the adhesive washer 1395 is placed on edges of the case cover 1360. It should be noted that although FIGS. 15A and 15B show adhesive washer 1395 being located only on one edge of the case cover, it preferably is configured to be located on the entire perimeter of the case cover 1360. Generally the adhesive washer may be composed of two parts: an upper profile 1395A, which is located on top edges of the case cover and may be thicker with respect to an adhesive washer 1395B (tape) that is attached to the inside surface of the case cover and to the sealing gasket. The upper profile 1395A is thus configured to withstand mechanical crimping while provide effecting sealing of the battery cell. The underside adhesive washer may be a thin double sided adhesive layer being a part of the sealing gasket 1380 or not. The adhesive material may be chosen from a wide range of thermoplastics or other families.

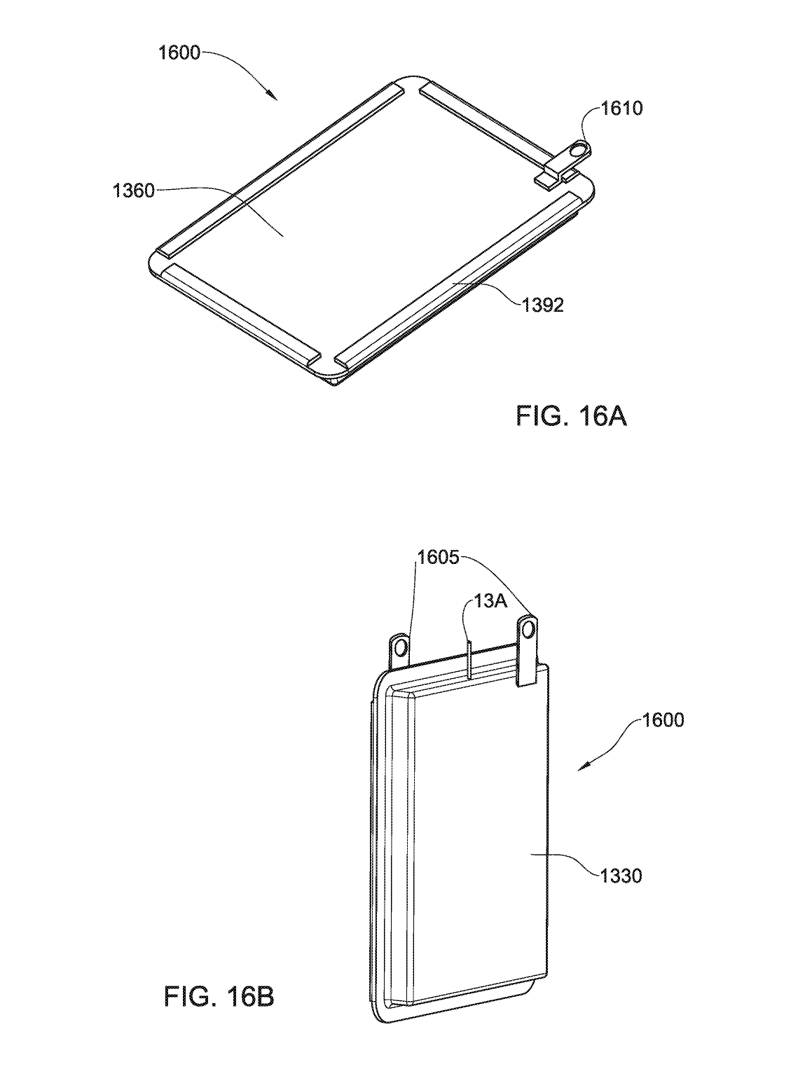

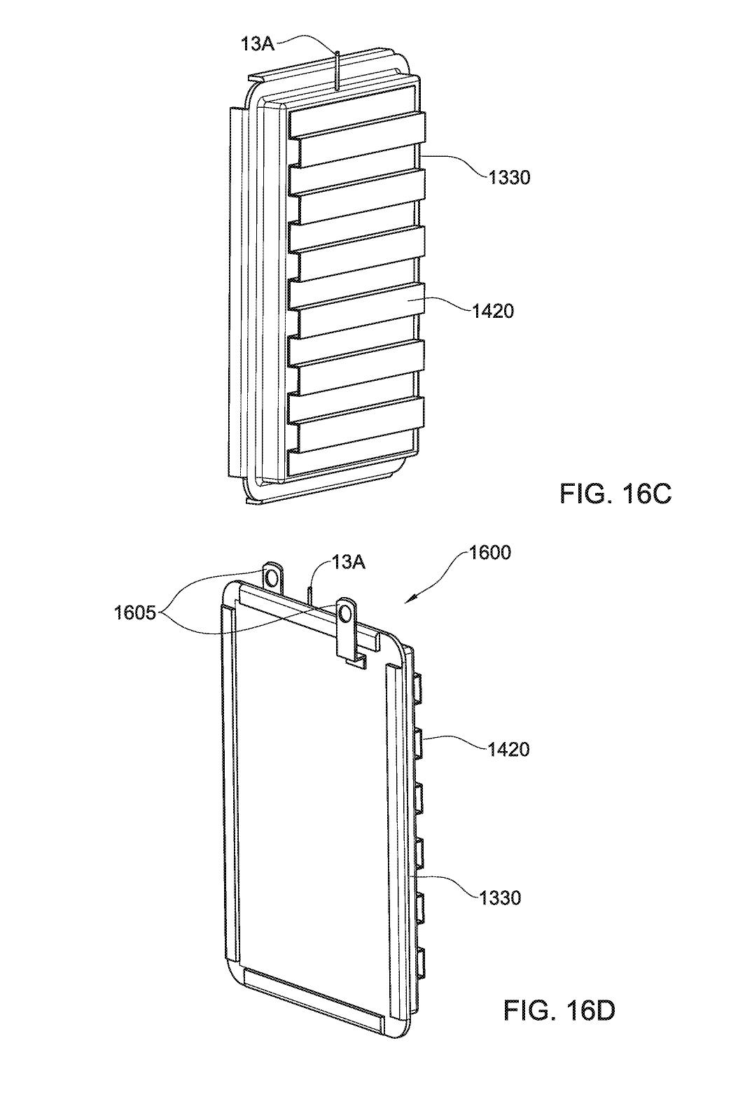

Reference is made to FIGS. 16A to 16E illustrating a closed battery cell unit 1600 and battery assembly 1650 according to embodiments of the invention. FIGS. 16A-16D show examples of a battery cell unit 1600 according to the embodiments of the present invention and FIG. 16E shows a battery assembly 1610 according to some embodiments of the present invention.

FIGS. 16A-16B show a battery cell unit 1600. The battery cell unit includes an enclosure 1330, a case cover 1360 defining together a volume in which the active elements, anode and cathode, are located. Also shown in FIG. 16B is a filling tube 13A configured for providing electrolyte into the battery cell after the pack is sealed as described above with reference to FIG. 14B. The battery cell unit shown in these figures also includes two unit connectors 1605. The connectors 1605 are configured for bolting/connecting different battery cell units into a battery assembly as will be described further below.

FIGS. 16C and 16D illustrate the use of a corrugated metallic separator 1420, which may be attached or welded to the metallic enclosure 1330. FIG. 16C shows the enclosure 1330 with a filling tube 13A and a cooling fin assembly 1420 configured to provide electrical conduction between adjacent battery cells in a battery assembly while allowing cooling fluid, e.g. air, to pass between the battery cells and provide effective cooling. FIG. 16D shows a closed battery cell unit 1600 with cooling fins 1420 and connectors 1605. It should be noted that the connectors 1605 may be used to allow the use of a bolt for connecting battery cells into an assembly. The battery cells may also be packed into an assembly or welded/soldered to one another.

Such a battery assembly is exemplified in FIG. 16E showing four battery cells bolted together to form an assembly 1610. As shown, the cooling fins 1420, or corrugated metallic connectors, provide electrical connection between the battery units while allowing passage of air or other cooling gases between the battery units. Also shown is the use of connectors 1605 for connecting the battery cells to one another by bolts. This simplifies the construction of the battery assembly 1610, removes the need to weld the cell unit together and enables facile replacement of individual cells if necessary.

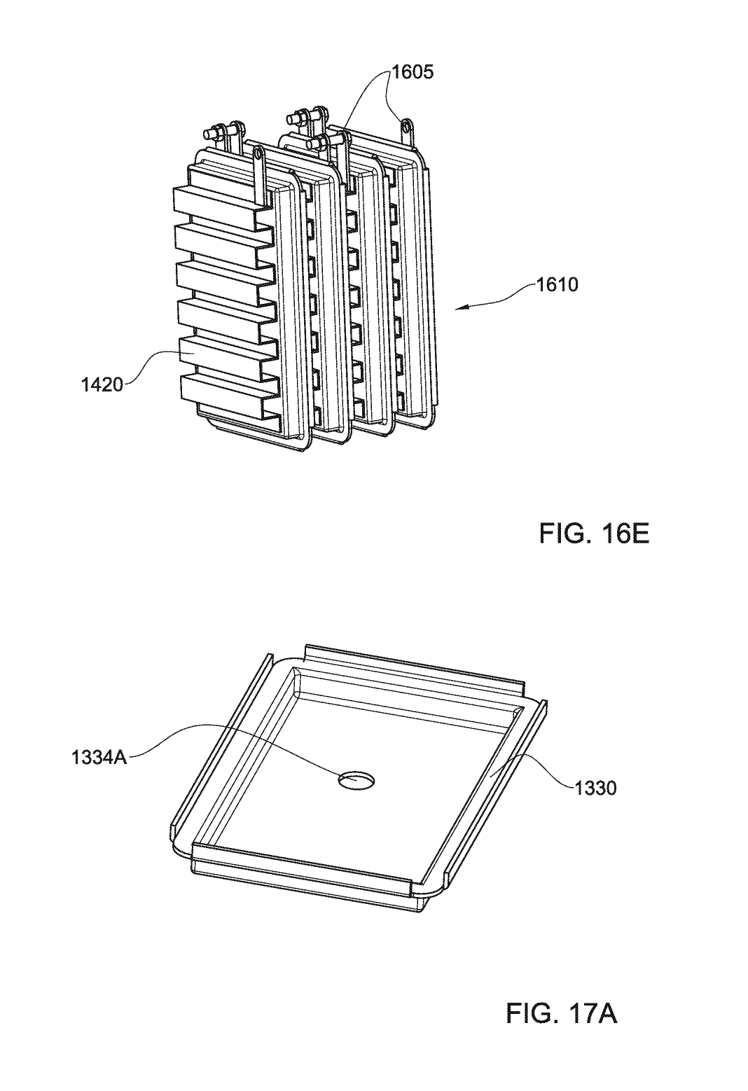

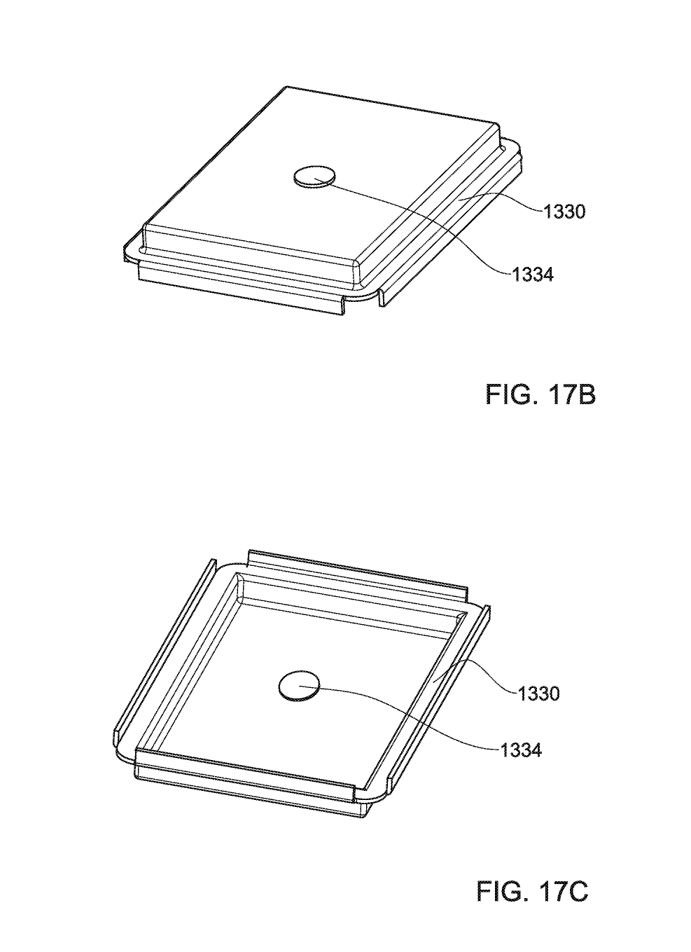

Reference is made to FIGS. 17A to 17C illustrating the first metallic enclosure 1330 according to some embodiments of the invention. In these figures the enclosure 1330 includes an implanted safety vent 1334. To this end, a hole 1334A is punctured in one of the surfaces of the enclosure 1330 (FIG. 17A), and internal and/or external patches are provided to close the hole. Cup shaped patches (not shown) may be employed instead if space allows. This provides sufficient sealing to the battery cell when operated normally. If, however, the battery cell unit is overheating, the increased pressure will cause the patches to burst out and controllably release the pressure thus preventing explosion of the battery cell unit.

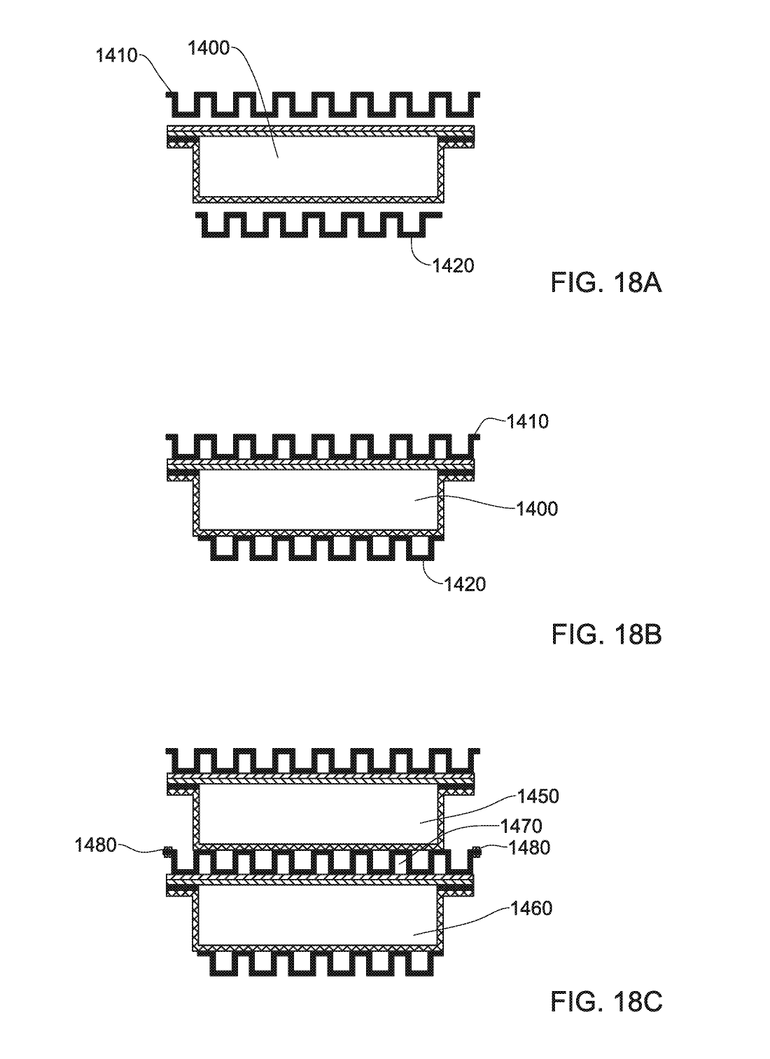

FIGS. 18A to 18C show suitable interconnections between the battery cell units illustrated in FIG. 13A. As indicated, the positive and negative terminals of the battery cell unit are provided by surfaces of the enclosure and the case cover. FIG. 18A illustrates a battery cell unit 1400 and two interconnectors 1410 and 1420 located one above the case cover and one below the enclosure. The connectors may be configured as corrugated metallic connectors, a metallic ladder and/or fins, providing electrical conductivity and close spacing between adjacent battery cell units while allowing flow of cooling fluid there between. FIG. 18B shows the interconnectors 1410 and 1420 when attached to the surfaces of battery cell unit 1400 and FIG. 18C shows an assembly of two batteries 1450 and 1460. As shown, the interconnectors 1470 are two sided connectors, which may be configured from lightweight, highly thermally conductive, electrically conductive material (e.g. aluminum) and may be configured to have high surface area to maximize the cooling effect of air/fluid/gas flow between the battery cell units. It should be noted that each of the battery cells 1450 and 1470 may be attached to top and bottom connectors 1470, and the connectors 1470 may then be configured to match together when placed one on top of the other. More specifically, the connectors 1470 may be configured as building blocks such that when placed one on top of the other they actually take up no more space with respect to a single connector. In this configuration, the connectors 1470 may be bolted one to the other at the edges 1480 and 1490 thereof.

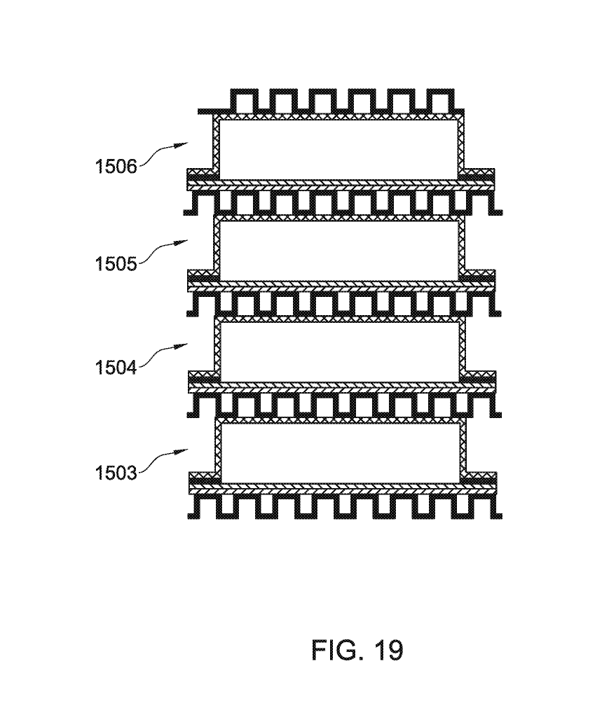

An example of battery assembly according to some embodiments of the present invention is shown in FIG. 19 illustrating an assembly of four battery cells 1503, 1504, 1505, 1506 as described above, separated by interconnectors providing electrical conductivity between the battery cells while allowing cooling thereof at close interspacing. The battery cell units are connected in series, however parallel connection may also be used, as the case may be, with suitable modifications to the assembly. As shown, cooling fluid, air or other gases can flow in between the battery cell units and, utilizing the large area of the interconnectors, provide effective cooling of the individual cells of the assembly. Such effective cooling allows the use of the battery assembly for high loads and long duty times with respect to the commercially available battery assemblies.

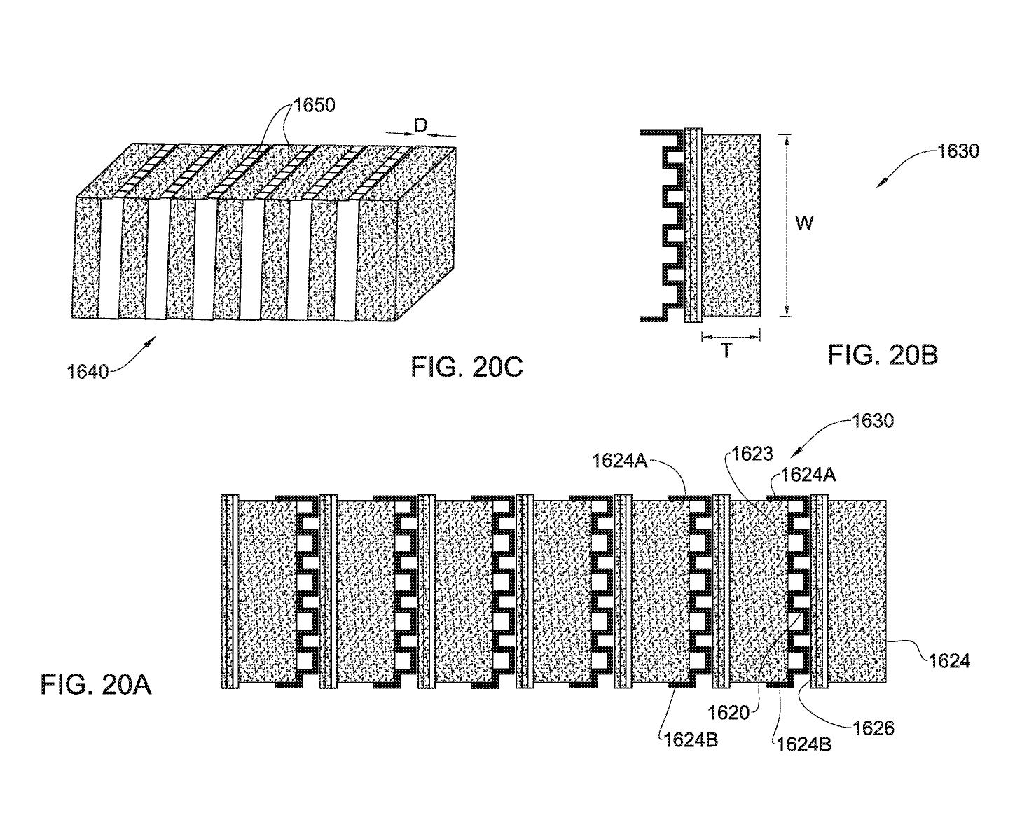

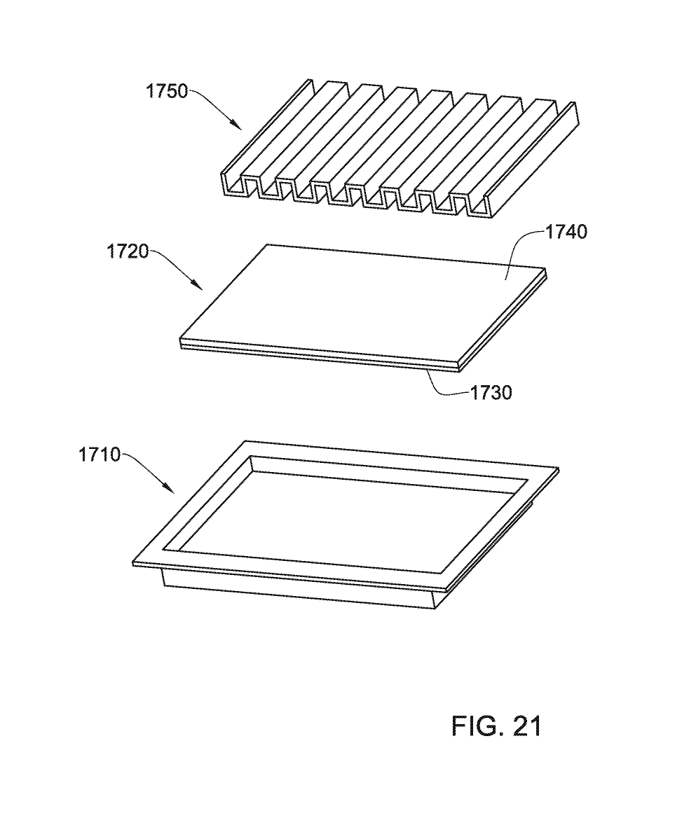

FIGS. 20A to 20C illustrate one other configuration of a battery assembly according to the present invention. FIG. 20A shows the connections between battery cell units and the corresponding interconnectors in the assembly 1630; FIG. 20B shows a battery cell 1630 unit with a single sided interconnector; and FIG. 20C illustrates a closed assembly 1640. In this example of the assembly, 7 battery cell units are shown, each having a single corrugated interconnector/cooling element 1650 between adjacent cells . . . . The interconnector 1650 may be welded or otherwise attached to the flat terminal face 1626 of cell 1624 and has upper and lower edge projections 1624A and 1624B configured to provide a firm grip with the side sections of adjacent cell. It should be noted that the structure of the assembly can be further tightened by use of screws that may be introduced at top and bottom of the corrugated elements (not specifically shown). It should also be noted that the interconnector 1620 may preferably be attached/welded to the case cover or the respective battery cell, to provide suitable attachment of the enclosure of the adjacent cell and provide effective electrical connection between them. This is exemplified in FIG. 20B showing a single battery cell unit and a corresponding interconnector attached to a surface of the case cover thereof. The battery cell 1630 unit has typical dimensions for thickness T and width W. Generally the width W of the battery cells is much larger than the thickness T thereof. FIG. 20C shows a battery assembly as described above with in a three dimensional view. Battery cell units as shown in FIG. 20C are configured with cell height H, width W, thickness T and the interconnector is configured to provide distance D between adjacent battery cells. Generally, T and H may be substantially equal to one another, while being much larger than the thickness T. For example, H and W can be 200 mm, but T is only 20 mm. The battery assembly is preferably configured with close spacing of adjacent cells such that a distance D between adjacent battery cell units is much smaller with respect to thickness of each battery cell unit. For example, D, the distance between battery cell units may not exceed 2 mm in this example, preferably the distance between battery cell units may be about 10% of the thickness of the battery cells.

FIG. 21 shows a simplified three dimensional exploded illustration of a battery cell enclosure 1710 (e.g. cathode enclosure and terminal), the corresponding case cover 1720 with inner thin copper layer 1730 and outer thicker aluminum layer 1740 and corrugated aluminum cooling fin connector 1750 shown before attaching/welding to the clad anode section. The corrugated cooling fin 1750 is shown with a turreted profile. The outer strips of the corrugated elements may be extended (not shown) beyond the plane of the corrugations to provide connector configuration as shown in FIG. 20B.

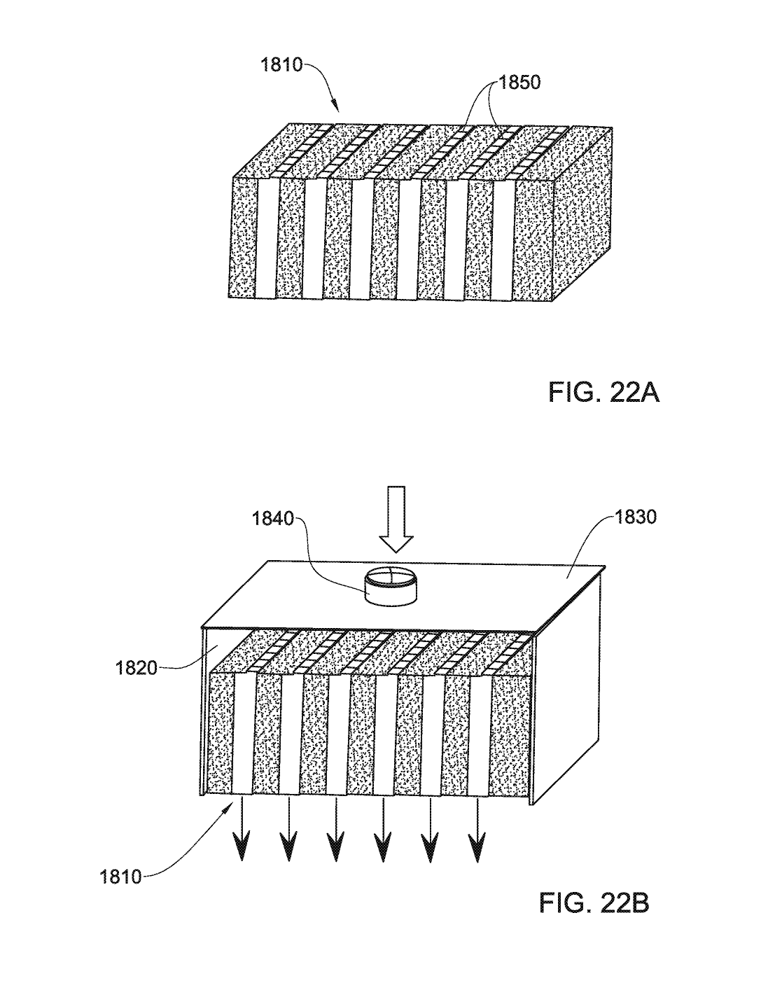

FIGS. 22A to 22B show three dimensional schematic illustrations of a six cell battery assembly unit 1810. FIG. 22A shows the battery assembly and FIG. 22B shows the battery assembly confined by electrically conducting end plates 1820 providing terminals thereof and an electrically insulating cover 1830. The cover is fitted with a fan 1840 configured to direct cooling air between corrugated elements 1850 separating between adjacent cells to provide cooling of the battery assembly.

A non-limiting example describes the steps of making a semi-bipolar battery unit.

### Example 1

Major steps of the process for a semi-bipolar lithium-ion cell assembly, according to one embodiment of the present invention (such as FIG. 6B).

1. Prepare cell flat anode terminal face (aluminum clad on copper) with welded-on corrugated aluminum piece on the aluminum side, and prepare cell cathode terminal face as an embossed aluminum tray with outer welded-on corrugated aluminum piece, the corrugations when suitably nested so devised as not to enlarge the intercell spacing beyond 10% or 20% of the cell thickness.
2. Prepare anode active material support (e.g. copper foil).
3. Add anode material on one side
4. Prepare cathode active material support (e.g. aluminum foil).
5. Add cathode material on one side.
6. Juxtapose anode and cathode active materials with separator between them and fold on a mandrel to give a Z-configuration stack.
7. Weld anode current collector to inner copper surface of clad aluminum copper case cover (cell anode terminal face having inbuilt corrugated element)
8. Weld cathode current collector to inner surface of embossed cathode tray (large terminal cathode face of cell having inbuilt corrugated element) and insert the electrode stack into the cavity between juxtaposed flat anode and embossed cathode terminal face
9. Seal edges of cell on three sides with hot melt thermoplastic foil.
10. Add electrolyte, perform electrode formation step and complete the cell sealing.
11. Juxtapose together adjacent cells in series such that the corrugated piece of one cell nests compactly with the corrugated piece of the next cell (one fitting within the other) and bolt together at the extremities of the corrugated pieces. This spaces uniformly the cells and allows cooling channels while enabling excellent cell-to-cell mechanical robustness, excellent cell-to-cell electrical conductivity, close cell spacing and facile removal and replacement of individual cells.
12. Insulate major faces, sides and rims of cells with a an insulating composition to prevent shorts
13. Arrange cells in a suitable support structure to give a multi-cell battery assembly.

Thus, the present invention provides a novel battery cell unit and battery assembly configuration allowing high electrical capacity and voltage within a small form factor battery cell. Additionally the battery assembly of the invention allows effective cooling of the battery cells while operation to increase reliability of provided current and voltage and prevent surges and short circuit due to overheating. The invention is capable of other embodiments and of being practiced and carried out in various ways. Those skilled in the art will readily appreciate that various modifications and changes can be applied to the embodiments of the invention as hereinbefore described without departing from its scope, defined in and by the appended claims.

1. A battery cell unit comprising:
a metallic enclosure comprising:
a first metallic case having a base tray and surrounding walls to thereby define an inner volume;
a second metallic case cover configured for closing said inner volume; and
a circumferential sealing material located along an interface between said first metallic case and said second metallic case cover to thereby seal said volume within the enclosure;
an anode element;
a cathode element; and
a separator that separates the anode element and cathode element from each other;
wherein said anode and cathode elements and the separator are immersed in electrolytic liquid to thereby allow ion exchange between the anode and cathode elements while preventing direct contact between the anode and cathode elements;
wherein the anode and cathode elements are respectively electrically connected to the metallic enclosure and metallic case cover.

2. The battery cell unit of claim 1, wherein said second metallic case cover is configured as a clad layered case cover having a first layer of a first metal and a second layer of a second metal.

3. The battery cell unit of claim 1, wherein said second metallic case cover is configured as a layered case cover having a first layer of a first metal thermally coated by a second layer of a second metal.

4. The battery cell unit of claim 2, wherein said first metallic case comprises said first metal, said second metallic case cover being configured such that said second layer thereof is directed into said inner volume and said first layer thereof is directed out of said inner volume.

5. The battery cell unit of claim 2, wherein said first metal includes aluminum (Al) and said second metal includes copper (Cu).

6. The battery cell unit of claim 1, wherein a circumference of said interface between the metallic enclosure and the metallic case-cover comprises at least one corner; said first metallic enclosure comprises a rim about a perimeter thereof, said rim being extended over edges of said second metallic case cover, said rim being crimped about perimeter of said first metallic enclosure and onto said second metallic case cover to thereby attach said case cover over said enclosure while maintaining at least one corner of said perimeter open to provide at least one safety valve for said battery cell unit.

7. The battery cell unit of claim 6, wherein a circumference of said interface between the metallic enclosure and the metallic case cover is configured with a polygonal shape.

8. The battery cell unit of claim 6 wherein said circumferential sealing material is located along an interface between said first metallic case and said second metallic case cover including location of said at least one safety valve.

9. The battery cell unit of claim 1, wherein said circumferential sealing material comprises an insulating sealing gasket having a structure selected to fit circumference of said battery cell unit.

10. The battery cell unit of claim 9, wherein said circumferential sealing material further comprises an additional adhesive material spread about said circumference of said battery cell unit.

11. The battery cell unit of claim 1, wherein the battery cell unit is configured such that an outer surface of the bottom tray of the first metallic element is a first terminal of the battery cell and a surface of the second metallic element is a second terminal thereof.

12. The battery cell unit of claim 1, further comprising an insulating layer located on external side walls of said battery cell unit thereby providing insulation of the battery cell unit.

13. (canceled)

14. (canceled)

15. (canceled)

16. A battery cell unit comprising:
a first metallic case having a substantially polygonal structure;
a second metallic case cover;
a circumferential sealing material;
an anode element;
a cathode element;
a separator that separates the anode element and the cathode element from each other;
wherein the anode and cathode elements are respectively electrically connected to the first and second metallic case and case cover;
wherein said first metallic case is crimped over said second metallic case cover along sides of said polygonal structure while leaving at least one corner thereof uncrimped so as to provide a safety vent for said battery cell unit.

17. (canceled)

18. (canceled)

19. (canceled)

20. A battery assembly comprising at least two battery cell units each configured according to claim 1, corresponding terminals of said at least two battery cell units being electrically connected in series or in parallel.

21. The battery assembly of claim 20, wherein said at least two battery cell units are electrically connected in series, each of said at least two battery cell units being configured such that a face of a first metallic element is a first terminal and a face of a second metallic element is a second terminal thereof.

22. The battery assembly of claim 20, wherein adjacent battery cell units of said at least two battery cell units are electrically connected therebetween via at least one metallic connection member providing a plurality of contact points on corresponding faces thereof.

23. The battery assembly of claim 22, wherein said at least one metallic connection member is a corrugated metallic connection member.

24. The battery assembly of claim 22, wherein said metallic connection member is configured to allow passage of cooling fluid between said adjacent battery cell units to thereby provide cooling of said battery cell units.

25. The battery assembly of claim 22, wherein the metallic connection member is configured such that a distance between adjacent battery cell units is smaller than 20% of a thickness of the battery cell unit.

26. The battery assembly of claim 25, wherein said distance is smaller than 10% of a thickness of the battery cell unit.
